(19) United States
(12) Patent Application Publication
(10) Pub. No.: US 2022/0388855 A1
(43) Pub. Date: Dec. 8, 2022

(54) MODULAR, TRANSPORTABLE CLEAN HYDROGEN-AMMONIA MAKER

(71) Applicant: FuelPositive Corporation, Toronto (CA)

(72) Inventors: Ibrahim Dincer, Toronto (CA); Ghassan Chehade, Toronto (CA); Osamah Siddiqui, Toronto (CA); Haris Ishaq, Toronto (CA)

(73) Assignee: FuelPositive Corporation, Toronto (CA)

(21) Appl. No.: 17/826,641

(22) Filed: May 27, 2022

Related U.S. Application Data
(60) Provisional application No. 63/197,884, filed on Jun. 7, 2021.

(51) Int. Cl. C01C 1/04; C25B 1/04; C25B 9/50; C25B 15/08; C25B 13/00; C25B 9/67

(52) U.S. Cl. CPC C01C 1/0417; C25B 1/04; C01C 1/0411; C25B 9/50; C25B 15/081; C25B 13/00; C25B 9/67

(57) ABSTRACT

A containerized system for producing anhydrous ammonia from air, water and a power source, includes a containerized hydrogen production unit that produces hydrogen gas from a water source by low temperature electrolyser, high temperature electrolyser, battolyser or by other methods; a containerized nitrogen production unit comprising an onboard air compression and storage unit that produces and stores pressurized air, a pressure swing adsorption process or other methods that use regenerative molecule that does not need any maintenance, which intakes compressed air and produces nitrogen gas through a series of adsorption and desorption processes, or other such methods of producing nitrogen from air; a containerized ammonia production unit comprising a gas booster that increases the pressure of a mixture of the hydrogen gas and the nitrogen gas using the pressurized air; a multi-reactor assembly joint in series or in parallel; and a recycle loop that separates the ammonia from unreacted gases.

### CROSS REFERENCE TO RELATED APPLICATIONS

This non-provisional application claims the benefit under 35 U.S.C. § 119(e) to U.S. Provisional Application No. 63/197,884, filed on Jun. 7, 2021, which is hereby expressly incorporated by reference into the present application.

### BACKGROUND OF THE INVENTION

### 1. Field of the Invention

The present invention entails the development of a modular, containerized, transportable hydrogen and/or anhydrous ammonia producer that utilizes only air, water, and electricity (particularly clean electricity coming from renewables) as system inputs.

### 2. Description of the Background Art

Conventional hydrogen and/or ammonia synthesis is recognized as environmentally detrimental due to the usage of carbon entailing hydrocarbon fuels, which result in significant harmful emissions during manufacturing stage. The production process of ammonia by the synthesis of nitrogen and hydrogen at high temperature and pressure is old in the art. The hydrogen and nitrogen which are utilized as initial products in the said ammonia synthesis process can be prepared in a diversity of ways. Nearly all existing ammonia production plants across the globe primarily use such fossil fuels to synthesize into ammonia through the Haber-Bosch process. Also, current ammonia synthesis entails a centralized production where only large chemical plants and industries synthesize this important chemical that is used extensively in various sectors. In light of the forgoing, recent art has focused on cleaner methods to produce ammonia from air and water as a sustainable feedstock (see US 2011/0243828 A1, US 2013/0039833 A1, US 2019/0092645 A1). Although, it is known that on passing a mixture of nitrogen extracted from air (by pressure swing absorption or any other process) and hydrogen extracted from water (by electrolysis or any other process) over a catalyst at a raised temperature and pressure a small fraction of the gases is converted into ammonia.

For instance, in US 2011/0243828 A1 the inventor discloses a process methodology using a piston as the driving force to create pressure and a cylinder as a pressurized vessel to produce ammonia from air and water, comprising producing nitrogen gas from air by pressure-swing adsorption; producing hydrogen gas by electrolysis of water; compressing the nitrogen gas in a first piston-cylinder to produce pressurized nitrogen gas; compressing the hydrogen gas in second piston-cylinder to produce pressurized hydrogen gas; compressing a mixture of the pressurized nitrogen and hydrogen gases in a third piston-cylinder, heating the compressed mixture in the presence of a catalyst to react nitrogen and hydrogen to form ammonia; and extracting the ammonia from the mixture. However, it is well known that driving a piston into a cylinder without the presence of lubricants can be highly inefficient and with lubricants can cause contamination in the reaction vessel and thus affecting the ammonia yield. Also, the requirement of such mechanical components require high maintenance cost that makes the system difficult to be commercialized and inefficient.

In US 2013/0039833 A1, there is a disclosure of an ammonia production process involving air and water as a feedstock powered by a renewable energy source such as wind power. The disclosed process utilizes an electrolysis process where water is decomposed into hydrogen and oxygen by providing an electrical source. The nitrogen is extracted from air by the pressure swing adsorption process. Here, the nitrogen and hydrogen are blended to form a synthesis gas stream. The unreacted gas stream is compressed to high pressure then mixed with recycling reacted synthesis gas before entering the reactor. The reacted synthesis gas is then cooled to below the dew point of ammonia by indirect heat exchange with colder fluids, such as an unreacted synthesis gas stream, or ambient water. The cooling reduces the pressure and allows the ammonia to condense into liquid form. However, the system of US 2013/0039833 A1 does not include a preheater, so the ammonia reaction is not conducted at an ideal temperature and pressure.

In US 2019/0092645 A1, ammonia is synthesized by adopting an electrolysis method in which the synthesized ammonia substantially does not contain hydrogen, in combination with ammonia separation and recovery treatment using membrane separation or PSA. Rather, US 2019/0092645 A1 utilizes a direct electrochemical synthesis of ammonia in an electrolytic reactor containing water and nitrogen. Herein, a reactor in which water is subjected to electrolysis by an electrolysis method is used, and a generated hydrogen ion and nitrogen are allowed to react with each other to synthesize ammonia. However, ammonia synthesis from water directly or in scientific terms “electrochemically” is not viable in a commercial setting. Scientific breakthrough in ammonia synthesis directly from water is achievable, but the rate of ammonia production is too low, and the energy consumption is not acceptable at scale. For example, the standard electrochemical potential for the ammonia synthesis reaction is 1.127 Volts while the standard electrochemical potential for water electrolysis is 1.23 Volts. The theoretical cell potential for ammonia synthesis and water electrolysis are very close, and this becomes a real problem to solve in direct synthesis of ammonia from water and nitrogen. In actual setting the cell potential for ammonia synthesis is much higher than that of hydrogen production. Thus, hydrogen production reaction will always be more favorable than ammonia synthesis thermodynamically.

Furthermore, other ammonia synthesis developments include integrated systems and other methods of separation processes (for example, see CN 2021/111498868B, EP 2013/2610453 A1, US 2012/0100062 A1, US 2006/0243585).

Also, it is well known in the state of art when an attempt is made to use a condensation separation process, such as membrane separation or pressure swing adsorption, it is difficult to separate ammonia from hydrogen when ammonia is to be recovered on a permeation side or a non-adsorption side, and it is also difficult to separate ammonia from nitrogen when ammonia is to be recovered on a non-permeation side or an adsorption side, with the result that the rate of ammonia recovery is extremely reduced.

In contrast to the ammonia synthesis developments discussed above, the present invention is a unique one with its containerized, modular, and transportable hydrogen-ammonia synthesizer. In other words, the developed system is a containerized and transportable size anhydrous ammonia synthesizer (with flexible production capacities), which can be used as a clean hydrogen-ammonia system using renewable energy electricity. Ammonia synthesis is conventionally carried out in large industrial plants and facilities, and thus, the present system would allow modularized generation of hydrogen-ammonia rather than relying on large-scale plants to produce, store, and transport ammonia where it is required. The present invention achieves a working prototype that provides a modular, transportable, efficient, reliable, containerized, environmentally friendly, and sustainable method of producing ammonia that can aid in overcoming the challenges of harmful environmental emissions, inefficient conversion practices, and centralized production requirements, which are currently associated with conventional ammonia production techniques.

### SUMMARY OF THE INVENTION

In one embodiment of the present invention, a new modular and containerized hydrogen-ammonia producer is developed that can produce ammonia in an environmentally benign, modular, transportable, decentralized, and convenient method. The system provides the potential to overcome the challenges associated with current centralized hydrogen and ammonia synthesis facilities. At present, the conventional synthesis of hydrogen and ammonia occurs only in large stick-built chemical plants. This method of centralized production poses several problems and challenges with the transportation as well as storage of ammonia. Hence, the ammonia producer of the present invention aids in solving these challenges through its transportability that allows it to be taken to any location where ammonia is required. In this embodiment, the system provided herein comprises a single containerized system or multiple containerized subsystems forming the transportable hydrogen and ammonia system. Many commercially available shipping containers can be adapted for use in the transportation and deployment of the systems provided herein by one skilled in the art (see for example, U.S. 2013/0233755 A1 and WO 2006/045077). With the present systems and methods provided herein, there is no need to transport the hydrogen and ammonia from site of manufacture to point of application.

The term “containerized” generally encompasses commercially built containers that are used for shipping goods from one site to another. Commercial shipping containers can be of different standard sizes and classification. For example, the standard sizes for shipping containers are 10 ft, 20 ft, 30 ft, 40 ft, and 45 ft where the classification of such containers may include and is not limited to: ATEX certified explosion proof, Class 1 Div. 1 & 2/Class 1, Zone 1 & 2/Class 3, Div. 1 &2. The term “transportable” generally involves the method of transportation or shipping which includes transportation by air, water, or land.

Furthermore, the system of the present invention synthesizes both hydrogen and anhydrous ammonia in an environmentally benign way through the usage of air and water as inputs. Thus, the present invention overcomes the massive emission factors associated with the current ammonia synthesis plants. The ammonia producer of the present invention utilizes new design methodologies and system integration techniques for the clean synthesis of ammonia in a containerized commercial manner. The hydrogen required for ammonia synthesis is obtained through a state of the art low temperature electrolyser, high temperature electrolyser, battolyser or by other such methods of producing hydrogen from a liquid/vapor medium where the produced hydrogen has a minimum purity of 99.995%. In addition, the nitrogen required for ammonia synthesis is obtained through a pressure swing adsorption (PSA) process or other methods of producing nitrogen, which intakes pressurized air and produces nitrogen gas through a series of adsorption and desorption processes, or other such methods of producing nitrogen from air where the produced nitrogen has a minimum purity of 99.995%. The produced hydrogen and nitrogen gases are dried in a series of expansion/buffer tanks, either pressurized to the reaction pressure or blended at the same pressure and boosted to the reaction pressure and then heated to the reaction temperature in a separate vessel required for ammonia synthesis through an onboard mixed gas boosting mechanism. The buffer tanks are used to store the hydrogen and nitrogen at the reaction pressure and may utilize a compression accumulator system connected to a hydraulic tank to further maintain the ideal reaction pressure. Furthermore, an open top configuration ammonia synthesis reactor with a suitable catalyst produces ammonia gas. Two different techniques of system operation comprising a cascaded reactor configuration and a parallel reactor configuration may be involved in the modular clean ammonia synthesis system of the present invention. The multi-reactor assembly can be a set of reactors joint in series or in parallel suitable to control the production and maximize the yield of ammonia. The reactor exhaust passes through a series of heat exchangers and condenser that allows ammonia to liquefy and separate from the unreacted mixture. In the alternative, the reactor exhaust passes through a heat exchanger to reheat the recycled gases plus heating the new input gases while cooling the exhaust gases. This process will allow the system to continue operating without adding further heat by using the reaction heat as the new energy source, further reducing the energy required.

One embodiment of the present invention is directed to a containerized system for producing anhydrous ammonia from air and water, comprising a state of the art low temperature electrolyser, high temperature electrolyser, battolyser or by other such methods of producing hydrogen from a liquid/vapor medium where the produced hydrogen has a minimum purity of 99.995%; a pressure swing adsorption air separation unit that extracts nitrogen gas from air; an air compressor that produces pressurized air; a mixed gas booster that increases the pressure of a mixture of the hydrogen gas and the nitrogen gas using the pressurized air; multiple reactors wherein a first reactor preheats the mixture of the hydrogen and nitrogen gases from the gas booster and a multi-reactor assembly is loaded with a catalyst for catalyzing the preheated mixture of the hydrogen and nitrogen gases to form ammonia at an ideal pressure and temperature; and a recycle loop that separates the ammonia from unreacted gases.

This embodiment may further comprise a water reservoir with a submersible pump that pumps water through the air compressor for cooling; a first line that allows water heated by the air compressor to exit the air compressor and enter the electrolyser to convert the heated water into hydrogen gas; and a second line that allows unreacted water and oxygen to exit the electrolyser and return to the water reservoir.

The recycle loop may comprise an air-cooled or water-cooled condenser that condenses ammonia gas into liquid ammonia; and a third line that allows the unreacted gases to return to the gas booster or the first reactor. The recycle loop may further comprise one or more anhydrous ammonia collection vessels connected in parallel at a bottom of the collection vessels to allow the anhydrous ammonia to settle in both collection vessels and to keep the pressure in the collection vessels at equilibrium. On the other hand, the recycle loop may comprise an absorption cooling system-based refrigeration unit that operates via waste heat in the system and liquefies ammonia gas; and a third line that allows the unreacted gases to return to the gas booster or the first reactor.

This embodiment may also further comprise a compressed air storage tank that stores the pressurized air from the air compressor. An exit of the gas booster may be connected to the first reactor or to the heating side of the catalyst reactor assembly exhaust heat exchanger where the mixture of the hydrogen and nitrogen gases are preheated to produce ammonia, and an exit of the first reactor may be connected to the multi reactor assembly in the presence of a suitable catalyst where further conversion of the mixture of the hydrogen and nitrogen gases to ammonia occurs at a suitable temperature range of 200° C. to 350° C. and a pressure range of 100 bar to 200 bar. The multi-reactor assembly can be a set of reactors joint in series or in parallel suitable to control the production and maximize the yield of ammonia. Correspondingly, the cooling side of the heat exchanger may be used to cool the exit gases from the catalyst reactor prior to entering the aforementioned ammonia condensation system.

Another embodiment of the present invention is directed to a containerized process for producing ammonia from air and water, comprising producing hydrogen gas from water with a water electrolyser; extracting nitrogen gas from air with a pressure swing adsorption air separation unit; producing pressurized air with an air compressor; increasing the pressure of a mixture of the hydrogen gas and the nitrogen gas using the pressurized air with a gas booster; preheating the mixture of the hydrogen and nitrogen gases from the gas booster in a first reactor; catalyzing the preheated mixture of the hydrogen and nitrogen gases to form ammonia in a multi reactor assembly loaded with a catalyst; and separating the ammonia from unreacted gases in a recycle loop.

This embodiment may further comprise pumping water in a water reservoir through the air compressor for cooling with a submersible pump; allowing the water heated by the air compressor to exit the air compressor and enter the electrolyser to convert the heated water into hydrogen gas; and allowing unreacted water and oxygen to exit the electrolyser and return to the water reservoir. The preheating step may further comprise increasing the pressure of the mixture of the hydrogen and nitrogen gases.

The separating step may comprise condensing ammonia gas into liquid ammonia in an air-cooled or water-cooled condenser; and allowing the unreacted gases to return to the gas booster or the first reactor. The separating step may further comprise allowing the liquid ammonia to settle at a bottom of one or more ammonia collection vessels connected in parallel wherein the pressure in the collection vessels is kept at equilibrium. On the other hand, the separating step may comprise liquefying ammonia gas with an absorption cooling system-based refrigeration unit that operates via waste heat in the system; and allowing the unreacted gases to return to the gas booster or the first reactor.

This embodiment may also further comprise storing the pressurized air from the air compressor in a compressed air storage tank. An exit of the gas booster may be connected to the first reactor where the mixture of the hydrogen and nitrogen gases are preheated and produce ammonia, and an exit of the first reactor may be connected to a multi reactor assembly where further conversion of the mixture of the hydrogen and nitrogen gases to ammonia occurs. On the other hand, an exit of the gas booster may be connected to both the preheater and the multi reactor assembly. The catalyst in the multi-reactor assembly may be a multi-bed catalyst. The multi-reactor assembly can be a set of reactors joint in series or in parallel suitable to control the production and maximize the yield of ammonia. To operate on different loads, meaning turning on and off or varying the load of the system, requires a set of reactors that can respond quickly to the variation. The problem arises from the gas-to-gas heat transfer inside the reactor. To have fast response the heat transfer of the reactor must be designed with fast response to heating. The dimensions of the reactor depend on the catalyst loading, reaction rate, temperature and pressure and concentration of reactants. Ideally small reactors are favorable for catalyst synthesis because of their high wall-to-volume ratio; however, they suffer from small volume processing. Thus, the term multiple reactor assembly includes a set number of small reactors where the production rate of ammonia is largely dependent on the number of reactors assembled together.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to one of ordinary skill in the art from this detailed description.

### BRIEF DESCRIPTION OF THE DRAWINGS

The present invention will become more fully understood from the detailed description given below and the accompanying drawings that are given by way of illustration only and do not limit the present invention. In the drawings, like reference numerals are used to indicate like features in the various views.

FIG. 1 is a schematic representing the overall process flow of the present invention.

FIG. 2 shows another embodiment of the present invention of a less energy intensive ammonia adsorption process.

FIG. 3 is a schematic representation of a cascade reactor configuration of the present invention with quench.

FIG. 4 is a schematic representation of a parallel reactor system operation configuration of the present invention.

FIG. 5 is a schematic representation of ammonia skid with heat recovery of the present invention.

FIG. 6 depicts the present invention of an ammonia batch process and configuration with multiple outputs.

FIG. 7 is a schematic representation of the salt production and carbon capture by employing the transportable ammonia producer of the present invention.

### DETAILED DESCRIPTION OF THE INVENTION

A containerized, transportable green ammonia producer of the present invention produces anhydrous ammonia from air, water, and electrical input. A preferred system is uniquely designed to enclose all components within a compartment size ranging from a 20-foot container to many containers and operate with only electricity, water, and air as inputs. However, larger or smaller transportable configurations are also possible, depending on the desired output preferably between 50 kg/day to a 1000 kg/day.

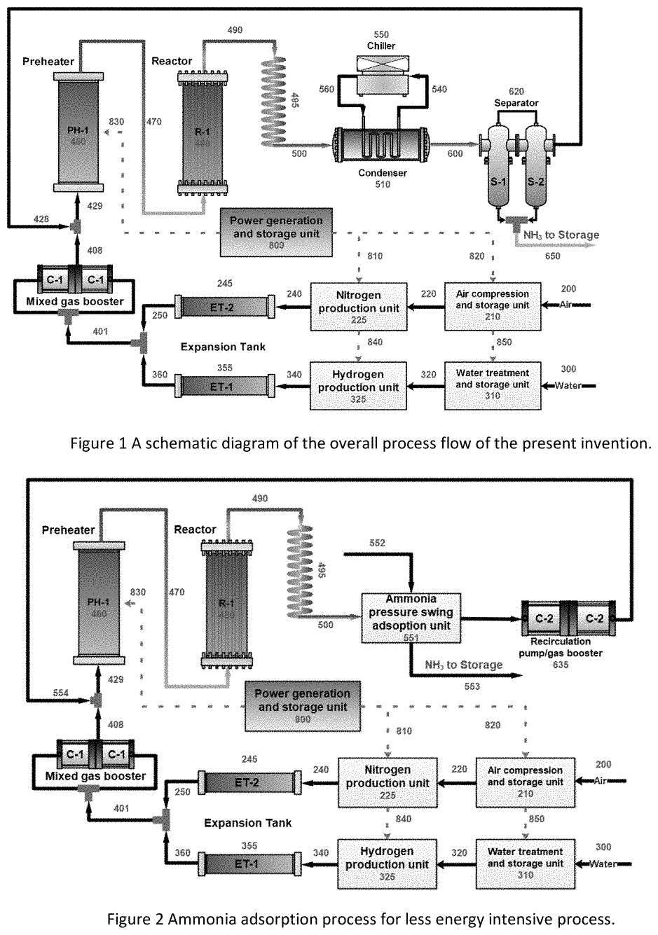

FIG. 1 is a schematic representing the overall process flow of the present invention.

An air inlet 200 allows air (preferably at room temperature and atmospheric pressure) to enter an air compression and storage unit 210. The air compression and storage unit 210 intakes the atmospheric air and pressurizes it. The air compression and storage unit 210 can store air at a high pressure, preferably at 10 to 100 bar, more preferably at 70 to 100 bar. The air can then be regulated to a lower pressure as required. For example, the air can be used at 4-30 bar, preferably 4-5 bar. This pressure is required to conduct an adsorption process followed by desorption processes. The compression and storage unit 210 may be a reciprocating compressor or a screw compressor. The air compression and storage unit 210 pressurizes atmospheric air and sends it to a nitrogen production unit (NPU) 225 via an inlet 220. The inlet 220 provides air to the NPU 225 at a regulated pressure, preferably 3-6 bar. The NPU 225 provides adsorption-based separation of oxygen and nitrogen from air. The adsorbents may be carbon molecular sieves, zeolites, or other suitable adsorbents. For example, the NPU 225 may include an enclosed container filled with carbon molecular sieves. The pressurized atmosphere within the container and the presence of molecular sieves allow the adsorption of oxygen molecules from the air. Thus, once the oxygen molecules are adsorbed, the remaining nitrogen molecules are allowed to exit the container and enter another enclosed compartment. The nitrogen exits the NPU 225 via an NPU outlet 240 and enters an expansion tank 245. The nitrogen in the NPU outlet 240 is preferably at 26-46° C., 10-50 bar, as high as 99.995% pure, and at a dew point of 5 ppm or less. The nitrogen in the expansion tank 245 cools slightly, preferably to 25-40° C. The expansion tank 245 can be any size but preferably has a volume of 0.5 to 2 m³. The expansion tank 245 may contain sieve molecules to dry the nitrogen and may also comprise an accumulator and bladder hydraulic system to maintain a pressure between 10 to 50 bar. Once needed, the nitrogen exits the expansion tank 245 via a nitrogen expansion tank outlet 250.

A water inlet 300 allows water (preferably at room temperature and 3-5 bar) to enter a water treatment and storage unit 310. The water may be pure water. The water may also be brine, sea water, saline water, or wastewater if a water treatment process is integrated with the system. As such, the water treatment and storage unit 310 may include a reverse osmosis process, brine purification, or a wastewater treatment process. The water then exits the water treatment and storage unit 310 via a water treatment and storage unit outlet 320, preferably at a temperature of 30-60° C. and a pressure of 3-5 bar and enters a hydrogen production unit (HPU) 325 that generates onboard hydrogen. The hydrogen production unit 325 may be a low temperature electrolyser, high temperature electrolyser, battolyser or by other such methods of producing hydrogen from a liquid/vapor medium where the produced hydrogen has a high purity of 99.995%.

The hydrogen production unit 325 may be a low temperature PEM electrolyser utilized with a unique methodology in the system of the present invention wherein water is first preheated through the utilization of waste heat. Increasing the temperature of input water to the hydrogen production unit 325 aids in enhancing the hydrogen production rates as well as the overall system efficiencies. Thus, a new water circulating design that provides cooling to the air compression and storage unit 210 and acts as the input to the hydrogen production unit 325 to enhance hydrogen production during ammonia synthesis may be employed. The hydrogen production unit 325 is preferably a high-pressure PEM electrolyser that can introduce hydrogen gas in the system at a pressure of 2-50 bar (more preferably 10-50 bar), but the exact pressure is determined by the rated output of the type of electrolyser that is selected. In a PEM electrolyser a solid electrolyte such as Sulfonated polystyrene is used. A membrane made of Nafion is placed to separate the anode and the cathode compartment. The membrane's role is to separate the hydrogen from the oxygen while allowing the transport of the H⁺. At the anode H₂O is consumed while at the cathode H₂O is used to lower the temperature of the electrolyser. This is done by circulating the water in both compartments. The temperature in the hydrogen production unit 325 is preferably 25-46° C.

The hydrogen exits the hydrogen production unit 325 via an HPU outlet 340. The hydrogen is preferably at 25-46° C., 10-50 bar, as high as 99.995% pure, and at a dew point of 5 ppm or less. The hydrogen then enters a hydrogen expansion tank 355. The hydrogen expansion tank 355 can be any size but preferably has a volume of 0.5 to 2 m³. The hydrogen expansion tank 355 may contain phosphorus pentoxide to dry the hydrogen and may also comprise an accumulator and bladder hydraulic system to maintain a pressure between 10 to 50 bar. Once needed, the hydrogen exits the hydrogen expansion tank 355 via a nitrogen expansion tank outlet 360. The pressure of the hydrogen can be regulated via pressure regulators.

The nitrogen exiting the expansion tank 245 via the nitrogen expansion tank outlet 250 and the hydrogen exiting the hydrogen expansion tank 355 via the nitrogen expansion tank outlet 360 both enter a nitrogen and hydrogen input 401 at 25-40° C. and 10-50 bar. The expansion tank 245 and the hydrogen expansion tank 355 can be used to control the inflow of gases into the nitrogen and hydrogen input 401 at a stoichiometric ratio of 1 mole of nitrogen gas for every 3 moles of hydrogen gas. This ratio is close to optimal, but other ratios are possible. Different ratios will yield different amounts. A reactant mixture of the molar ratio of 1 mole of nitrogen gas for every 3 moles of hydrogen gas can be obtained through the usage of mass flow controllers and solenoid valves. A nitrogen mass flow controller may control the flow rate of nitrogen, and a hydrogen mass flow controller may control the hydrogen flow rate.

The reactant mixture of hydrogen and nitrogen with the appropriate molar ratio enters a mixed gas booster. The gas booster increases the reactant mixture pressure from approximately 4 to 30 bar (preferably 25 to 30 bar) to around 90-180 bar, preferably 145 bar plus or minus 10 bar (more preferably 135 to 150 bar). However, the pressure is not particularly limited and may be any suitable pressure based on the type of other components chosen in the system. The gas booster can also be replaced with a mixed gas compressor to compress the mixture of hydrogen and nitrogen at high pressure. A hydrogen compressor will also eliminate the need for a compressed air storage tank from the system of the present invention.

The mixed gas then exits the gas booster via a mixed gas booster outlet 408 wherein pressure and flow can be controlled via regulator valve and mass flow controllers, respectively. The mixed gas then enters a preheater 460, which is equipped with electric heaters with a heating power between 10 to 100 kW (preferably at a range of 10 to 40 kW), via a preheater inlet 429. The preheater 460 may be any desired size but preferably has a volume of 0.008 to 0.1 m³ and is tubular in shape. The preheater 460 may be made from stainless steel. The preheater 460 increases the temperature and pressure of the mixed gas, preferably to 250-450° C. and 100-300 bar. The preferred operating temperature for the gases exiting the preheater 460 is 300° C. plus or minus 10° C. However, the temperature and pressure are not particularly limited and may be any suitable temperature and pressure based on the type of other components chosen in the system. The heated mixed gas then exits the preheater 460 via a preheater outlet 470, wherein pressure and flow can be controlled via regulator valve and mass flow controllers, respectively, and enters an ammonia reactor 480.

The ammonia reactor assembly 480 may be any desired size but preferably has a volume of 0.008 to 0.8 m³ (preferably at a range of 0.008 to 0.1 m³) and is tubular in shape. The reactor 480 is preferably made from a 316 stainless steel material or other suitable material with the size being determined by the process rate desired. To process 100 kg per day output, the reactor may have a length of approximately 1 to 2 meters and a diameter of approximately 10 to 20 centimeters. To process 300 kg per day output, 5 reactors may have a length of approximately 1 to 2 meters and a diameter of approximately 10 to 20 centimeters that are connected in best optimal arrangement, preferably in series or in parallel. The reactor contains a catalyst. The catalyst beds are axial radial cylindrical baskets with open screen top that can be inserted into a capsule. The capsule separates the catalyst basket from the pressure vessel walls (for cooling and even heat transfer along the walls). Radial flow is preferred with an open top configuration reactor. The capsule simplifies the operation of loading and unloading the catalyst. The catalyst is very sensitive to oxygen and requires careful consideration when loading it into the system. Thus, using the mentioned design descriptions, the catalyst can be loaded outside the system in the right conditions (nitrogen atmosphere for example, sieved to remove any dust and loaded by dense loader to ensure uniformity across the beds) and can be transferred and inserted into the reactor. The maintenance is performed after about 25 years due to aging and inactivity.

Furthermore, the temperatures and pressures inside the reactor 480 may be recorded through temperature and pressure sensors. The reactor 480 may be covered with an electric furnace with a heating power between 10 and 100 kW that utilizes electricity and heating coils to produce thermal energy, which is transferred to the reactor according to the required reaction conditions. This thermal energy can be used during startup and catalyst activation. The ammonia synthesis process is exothermic in nature, and as ammonia is produced, the heat generated is used to maintain the reactor 480 at high reaction temperatures. The reactor 480 is filled with an ammonia synthesis catalyst, such as a magnetite based commercial catalyst, that aids in the synthesis process. There are several possible catalysts commercially available. Lower synthesis pressure and temperature are desirable for energy savings and can be achieved with catalysts that can operate under low temperature and pressure. For example, promoters added to an iron oxide catalyst show great improvement in the catalyst structure and performance under a range of different operating temperatures and pressures. Also, non-ferrous catalysts such as ruthenium catalysts promoted with MgAl₂O₄, Al₂O₃, MgO, and different mixtures of cesium and barium are shown to be effective for low temperature and pressure ammonia synthesis. These contributed to the commercialization of the ammonia process that are known, such as the KAAP process and the KBR process.

The ammonia and the unreacted hydrogen and nitrogen gases exit the reactor 480 via a reactor outlet 490, wherein pressure and flow can be controlled via regulator valve and mass flow controllers, respectively, and enter a cooling coil 495. The shape and size of the cooling coil 495 can vary but is preferably a helical coil. The cooling coil 495 drops the temperature of the ammonia and the unreacted hydrogen and nitrogen gases to 50-200° C. The ammonia and the unreacted hydrogen and nitrogen gases then exit the cooling coil 495 via a cooling coil outlet 500 and enter a condenser 510.

The condenser 510 may be an air chiller, a water chiller, or a refrigerant-based chiller and may have a surface area of 0.1-0.8 m² (preferably at a range of 0.1 to 0.5 m²). The condenser 510 includes a condenser component inlet 540 wherein a refrigerant can enter a chiller 550 and then exit the chiller 550 via a condenser component outlet 560. The refrigerant can be air, water, or other refrigerants (e.g., R134A, R33, etc.). The chiller 550 may use vapor compression or vapor absorption cooling cycles. Vapor compression cycles operate with electrical input. Vapor absorption cycles operate with heat input. The pressures and temperatures of the refrigerants in the condenser component outlet 560 will depend on the type of the refrigerants used but are preferably −20 to −5° C. (more preferably −10 to −5° C.) and 5 to 10 bar. The pressures and temperatures of the refrigerants in the condenser component inlet 540 will also depend on the type of the refrigerants used but are preferably −5 to 1° C. and 1 to 5 bar.

The condenser 510 separates the ammonia produced from the unreacted hydrogen and nitrogen gases. Since the synthesis reactor 480 is operated at a high pressure of approximately 90-155 bar, preferably 145 bar plus or minus 10 bar, the produced ammonia is condensed through the condenser 510. However, the pressure is not particularly limited and may be any suitable pressure based on the type of other components chosen in the system. As the condensation temperature of ammonia increases with pressure, it is liquefied in the condenser 510 that entails partial pressures of ammonia according to the conversion rates. The liquid ammonia separates from the mixture and settles down in a separator 620 via a separator inlet 600. The remaining unreacted hydrogen and nitrogen gases are recycled and sent back to the inlet 429 via an unreacted gas outlet 428. Since the unreacted hydrogen and nitrogen gases are at a higher pressure than the preheater 460, the gases can be recycled without requiring another gas compressor. Thus, through this new methodology, the unreacted gases are recycled, and the ammonia produced is separated without the requirement of an additional refrigeration system.

The separator 620 may be a flash drum with a volume of 0.005 to 0.5 m³ (more preferably at a range of 0.005 to 0.05 m³). The ammonia then exits the separator 620 via a separator outlet 650 to a storage unit. The outlet pressure of the separator 620 can be varied via a regulator valve according to the required storage pressure.

A power generation and storage unit 800 provides power to any system components that need electricity. For example, the power generation may comprise an inverter and a battery integrated system. The unit 800 can use any source of power, including renewable energy resources such as wind, solar, tidal, geothermal, and hydropower. System components requiring electrical inputs include the HPU 325 via an electrical input 840, the NPU 225 via an electrical input 810, the air compression and storage unit 210 via an electrical input 820, the preheater 460 via an electrical input 830, and the water treatment and storage unit 310 via an electrical input 850. These components may be connected with electrical connections to form one connection that can be used to power the machine. Hence, the modular ammonia producer can be conveniently transported to any location having an electrical supply and can be connected to produce ammonia.

Another embodiment of the present invention is shown in FIG. 2, which is a less energy-intensive process.

Similar to FIG. 1, an air inlet 200 allows air (preferably at room temperature and atmospheric pressure) to enter an air compression and storage unit 210. The air compression and storage unit 210 intakes the atmospheric air and pressurizes it. The air compression and storage unit 210 can store air at a high pressure, preferably at 10 to 100 bar, more preferably at a range of 70 to 100 bar. The air can then be regulated to a lower pressure as required. For example, the air can be used at 4-30 bar, preferably 4-5 bar. This pressure is required to conduct an adsorption process followed by desorption processes. The compression and storage unit 210 may be a reciprocating compressor or a screw compressor. The air compression and storage unit 210 pressurizes atmospheric air and sends it to a nitrogen production unit (NPU) 225 via an inlet 220. The inlet 220 provides air to the NPU 225 at a regulated pressure, preferably 3-6 bar. The NPU 225 provides adsorption-based separation of oxygen and nitrogen from air. The adsorbents may be carbon molecular sieves, zeolites, or other suitable adsorbents. For example, the NPU 225 may include an enclosed container filled with carbon molecular sieves. The pressurized atmosphere within the container and the presence of molecular sieves allow the adsorption of oxygen molecules from the air. Thus, once the oxygen molecules are adsorbed, the remaining nitrogen molecules are allowed to exit the container and enter another enclosed compartment. The nitrogen exits the NPU 225 via an NPU outlet 240 and enters an expansion tank 245. The nitrogen in the NPU outlet 240 is preferably at 26-46° C., 10-50 bar, as high as 99.995% pure, and at a dew point of 5 ppm or less. The nitrogen in the expansion tank 245 cools slightly, preferably to 25-40° C. The expansion tank 245 can be any size but preferably has a volume of 0.5 to 2 m³. The expansion tank 245 may contain sieve molecules to dry the nitrogen and may also comprise an accumulator and bladder hydraulic system to maintain a pressure between 10 to 50 bar. Once needed, the nitrogen exits the expansion tank 245 via a nitrogen expansion tank outlet 250.

A water inlet 300 allows water (preferably at room temperature and 3-5 bar) to enter a water treatment and storage unit 310. The water may be pure water. The water may also be brine, sea water, saline water, or wastewater if a water treatment process is integrated with the system. As such, the water treatment and storage unit 310 may include a reverse osmosis process, brine purification, or a wastewater treatment process where the output water can be used to produce hydrogen. The water then exits the water treatment and storage unit 310 via a water treatment and storage unit outlet 320, preferably at a temperature of 30-60° C. and a pressure of 3-5 bar, and enters a hydrogen production unit (HPU) 325 that generates onboard hydrogen. In the HPU 325, water is dissociated electrochemically into oxygen and hydrogen gases. The hydrogen production unit 325 may be a low temperature electrolyser, high temperature electrolyser, battolyser or by other such methods of producing hydrogen from a liquid/vapor medium where the produced hydrogen has a high purity of 99.995%.

The hydrogen production unit 325 may be a low temperature AEM electrolyser utilized with a unique methodology in the system of the present invention wherein water is first preheated through the utilization of waste heat. Increasing the temperature of input water to the hydrogen production unit 325 aids in enhancing the hydrogen production rates as well as the overall system efficiencies. Thus, a new water circulating design that provides cooling to the air compression and storage unit 210 and acts as the input to the hydrogen production unit 325 to enhance hydrogen production during ammonia synthesis may be employed. The hydrogen production unit 325 is preferably a high pressure AEM electrolyser that can introduce hydrogen gas in the system at a pressure of 2-50 bar (more preferably 10-50 bar), but the exact pressure is determined by the rated output of the type of electrolyser that is selected. The temperature in the hydrogen production unit 325 is preferably at a range of 25 to 46° C.

The hydrogen exits the hydrogen production unit 325 via an HPU outlet 340. The hydrogen is preferably at 25-46° C., 10-50 bar, as high as 99.995% pure, and at a dew point of 5 ppm or less. The hydrogen then enters a hydrogen expansion tank 355. The hydrogen expansion tank 355 can be any size but preferably has a volume of 0.5 to 2 m³. The hydrogen expansion tank 355 may contain phosphorus pentoxide to dry the hydrogen and may also comprise an accumulator and bladder hydraulic system to maintain a pressure between 10 to 50 bar. Once needed, the hydrogen exits the hydrogen expansion tank 355 via a nitrogen expansion tank outlet 360. The pressure of the hydrogen can be regulated via pressure regulators.

The nitrogen exiting the expansion tank 245 via the nitrogen expansion tank outlet 250 and the hydrogen exiting the hydrogen expansion tank 355 via the nitrogen expansion tank outlet 360 both enter a nitrogen and hydrogen input 401 at 25-40° C. and 10-50 bar. The expansion tank 245 and the hydrogen expansion tank 355 can be used to control the inflow of gases into the nitrogen and hydrogen input 401 at a stoichiometric ratio of 1 mole of nitrogen gas for every 3 moles of hydrogen gas. This ratio is close to optimal, but other ratios are possible. Different ratios will yield different amounts. A reactant mixture of the molar ratio of 1 mole of nitrogen gas for every 3 moles of hydrogen gas can be obtained through the usage of mass flow controllers and solenoid valves. A nitrogen mass flow controller may control the flow rate of nitrogen, and a hydrogen mass flow controller may control the hydrogen flow rate.

The reactant mixture of hydrogen and nitrogen with the appropriate molar ratio enters a mixed gas booster. The gas booster increases the reactant mixture pressure from approximately 4 to 30 bar (preferably 25 to 30 bar) to around 80-280 bar, preferably 145 bar plus or minus 10 bar (more preferably 135 to 150 bar). However, the pressure is not particularly limited and may be any suitable pressure based on the type of other components chosen in the system. The gas booster can also be replaced with a mixed gas compressor to compress the mixture of hydrogen and nitrogen at high pressure. A hydrogen compressor will also eliminate the need for a compressed air storage tank from the system of the present invention.

The mixed gas then exits the gas booster via a mixed gas booster outlet 408 wherein pressure and flow can be controlled via regulator valve and mass flow controllers, respectively. The mixed gas then enters a preheater 460, which is equipped with electric heaters between 10 to 100 kW (preferably at a range of 10 to 40 kW), via a preheater inlet 429. The preheater 460 may be any desired size but preferably has a volume of 0.008 to 0.8 m³ (more preferably at a range of 0.008 to 0.1 m³) and is tubular in shape. The preheater 460 may be made from stainless steel. The preheater 460 increases the temperature and pressure of the mixed gas, preferably to 250-450° C. and 80-280 bar (preferably at a range of 100 to 280 bar). The preferred operating temperature for the gases exiting the preheater 460 is 300° C. plus or minus 10° C. However, the temperature and pressure are not particularly limited and may be any suitable temperature and pressure based on the type of other components chosen in the system. The heated mixed gas then exits the preheater 460 via a preheater outlet 470, wherein pressure and flow can be controlled via regulator valve and mass flow controllers, respectively, and enters an ammonia reactor 480.

The ammonia reactor 480 may be any desired size but preferably has a volume of 0.008 to 0.8 m³ (preferably at a range of 0.008 to 0.1 m³) and is tubular in shape. The reactor 480 is preferably made from a 316 stainless steel material or other suitable material with the size being determined by the process rate desired. To process 100 kg per day output, the reactor can have a length of approximately 1 to 2 meters and a diameter of approximately 10 to 20 centimeters. To process 300 kg per day output, 5 reactors may have a length of approximately 1 to 2 meters and a diameter of approximately 10 to 20 centimeters that are connected in best optimal arrangement, preferably in series or in parallel. The reactor contains a catalyst. The catalyst beds are axial radial cylindrical baskets with open screen top that can be inserted into a capsule. The capsule separates the catalyst basket from the pressure vessel walls (for cooling and even heat transfer along the walls). Radial flow is preferred with an open top configuration reactor. The capsule simplifies the operation of loading and unloading the catalyst. The catalyst is very sensitive to oxygen and requires careful consideration when loading it into the system. Thus, using the mentioned design descriptions, the catalyst can be loaded outside the system in the right conditions (nitrogen atmosphere for example, sieved to remove any dust and loaded by dense loader to ensure uniformity across the beds) and can be transferred and inserted into the reactor. The maintenance is performed after about 25 years due to aging and inactivity.

Furthermore, the temperatures and pressures inside the reactor 480 may be recorded through temperature and pressure sensors. The reactor 480 may be covered with an electric furnace that utilizes electricity and heating coils to produce thermal energy, which is transferred to the reactor according to the required reaction conditions. This thermal energy can be used during startup and catalyst activation. The ammonia synthesis process is exothermic in nature, and as ammonia is produced, the heat generated is used to maintain the reactor 480 at high reaction temperatures. The reactor 480 is filled with an ammonia synthesis catalyst, such as a magnetite based commercial catalyst, that aids in the synthesis process. There are several possible catalysts commercially available. Lower synthesis pressure and temperature are desirable for energy savings and can be achieved with catalysts that can operate under low temperature and pressure. For example, promoters added to an iron oxide catalyst show great improvement in the catalyst structure and performance under a range of different operating temperature and pressure. Also, non-ferrous catalysts such as ruthenium catalysts promoted with MgAl₂O₄, Al₂O₃, MgO, and different mixtures of cesium and barium are shown to be effective for low temperature and pressure ammonia synthesis. These contributed to the commercialization of the ammonia process that are known, such as the KAAP process and the KBR process.

The ammonia and the unreacted hydrogen and nitrogen gases exit the reactor 480 via a reactor outlet 490, wherein pressure and flow can be controlled via regulator valve and mass flow controllers, respectively, and enter a cooling coil 495. The shape and size of the cooling coil 495 can vary but is preferably a helical coil. The cooling coil 495 drops the temperature of the ammonia and the unreacted hydrogen and nitrogen gases to 50-200° C. The ammonia and the unreacted hydrogen and nitrogen gases then exit the cooling coil 495 via a cooling coil outlet 500 and enter an ammonia pressure swing adsorption (PSA) unit 551.

The PSA unit 551 can utilize an adsorbent such as MgCl₂ to adsorb the ammonia under pressure. Thus, the energy of the process is reduced compared to the process of FIG. 1 because the condenser and chiller, which require high energy consumption, are eliminated. The adsorbent enters the PSA unit 551 via an ammonia PSA inlet 552. The ammonia is then collected via an ammonia PSA outlet 553 and stored. Thus, the PSA unit 551 separates the ammonia produced from the unreacted hydrogen and nitrogen gases. The remaining unreacted hydrogen and nitrogen gases are recycled and sent back to the preheater inlet 429 via an unreacted gas outlet 554. Since the unreacted hydrogen and nitrogen gases are at a higher pressure than the preheater 460, the gases can be recycled without requiring another gas compressor. Thus, through this new methodology, the unreacted gases are recycled, and the ammonia produced is separated without the requirement of an additional refrigeration system.

A power generation and storage unit 800 provides power to any system components that need electricity. The unit 800 can use any source of power, including renewable energy resources such as wind, solar, tidal, geothermal, and hydropower. System components requiring electrical inputs include the HPU 325 via an electrical input 840, the NPU 225 via an electrical input 810, the air compression and storage unit 210 via an electrical input 820, the preheater 460 via an electrical input 830, and the water treatment and storage unit 310 via an electrical input 850. These components may be connected with electrical connections to form one connection that can be used to power the machine. Hence, the modular ammonia producer can be conveniently transported to any location having an electrical supply and can be connected in to produce ammonia.

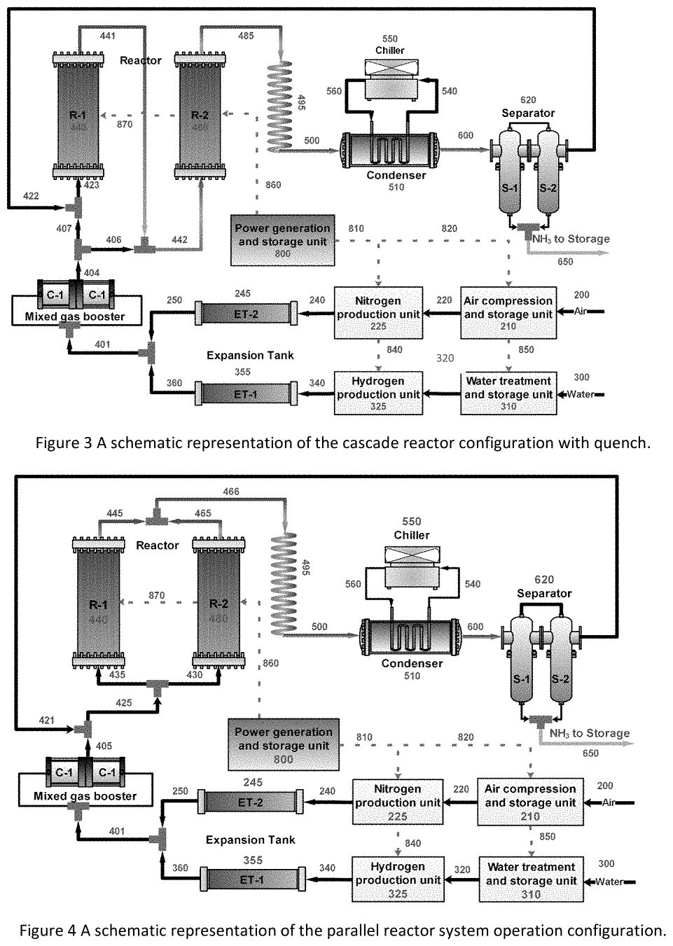

Another embodiment of the present invention is shown in FIG. 3, which provides a cascade reactor configuration with quench. The cascaded system configuration of FIG. 3 provides an increase in the ammonia synthesis rates by increasing the nitrogen conversion. As depicted in FIG. 3, the gas booster exit is connected to a reactor 440 where the input reactant gases attain a high pressure as well as temperature and produce ammonia. The exit of the reactor 440 is sent to a reactor 480 where further conversion of hydrogen and nitrogen gases to ammonia takes place.

Similar to FIG. 1, an air inlet 200 allows air (preferably at room temperature and atmospheric pressure) to enter an air compression and storage unit 210. The air compression and storage unit 210 intakes the atmospheric air and pressurizes it. The air compression and storage unit 210 can store air at a high pressure, preferably at 10 to 100 bar, more preferably at a range of 70 to 100 bar. The air can then be regulated to a lower pressure as required. For example, the air can be used at 4-30 bar, preferably 4-5 bar. This pressure is required to conduct an adsorption process followed by desorption processes. The compression and storage unit 210 may be a reciprocating compressor or a screw compressor. The air compression and storage unit 210 pressurizes atmospheric air and sends it to a nitrogen production unit (NPU) 225 via an inlet 220. The inlet 220 provides air to the NPU 225 at a regulated pressure, preferably 3-6 bar. The NPU 225 provides adsorption-based separation of oxygen and nitrogen from air. The adsorbents may be carbon molecular sieves, zeolites, or other suitable adsorbents. For example, the NPU 225 may include an enclosed container filled with carbon molecular sieves. The pressurized atmosphere within the container and the presence of molecular sieves allow the adsorption of oxygen molecules from the air. Thus, once the oxygen molecules are adsorbed, the remaining nitrogen molecules are allowed to exit the container and enter another enclosed compartment. The nitrogen exits the NPU 225 via an NPU outlet 240 and enters an expansion tank 245. The nitrogen in the NPU outlet 240 is preferably at 26-46° C., 10-50 bar, as high as 99.995% pure but preferably 99.999%, and at a dew point of 5 ppm or less. The nitrogen in the expansion tank 245 cools slightly, preferably to 25-40° C. The expansion tank 245 can be any size but preferably has a volume of 0.5 to 2 m³. The expansion tank 245 may contain sieve molecules to dry the nitrogen may also comprise an accumulator and bladder hydraulic system to maintain a pressure between 10 to 50 bar. Once needed, the nitrogen exits the expansion tank 245 via a nitrogen expansion tank outlet 250.

A water inlet 300 allows water (preferably at room temperature and 3-5 bar) to enter a water treatment and storage unit 310. The water may be pure water. The water may also be brine, sea water, saline water, or wastewater if a water treatment process is integrated with the system. As such, the water treatment and storage unit 310 may include a reverse osmosis process, brine purification, or a wastewater treatment process. The water then exits the water treatment and storage unit 310 via a water treatment and storage unit outlet 320, preferably at a temperature of 30-60° C. and a pressure of 3-5 bar, and enters a hydrogen production unit (HPU) 325 that generates onboard hydrogen. The hydrogen production unit 325 may be a proton exchange membrane (PEM), alkaline, photoelectrochemical, CuCl, or MgCl₂ based hydrogen production process wherein a hydrogen purity of 99.995% can be achieved.

The hydrogen production unit 325 may be utilized with a unique methodology in the system of the present invention wherein water is first preheated through the utilization of waste heat. Increasing the temperature of input water to the hydrogen production unit 325 aids in enhancing the hydrogen production rates as well as the overall system efficiencies. Thus, a new water circulating design that provides cooling to the air compression and storage unit 210 and acts as the input to the hydrogen production unit 325 to enhance hydrogen production during ammonia synthesis may be employed. The hydrogen production unit 325 is preferably a high-pressure PEM electrolyser that can introduce hydrogen gas in the system at a pressure of 2-50 bar (more preferably at a range of 10-50 bar), but the exact pressure is determined by the rated output of the type of electrolyser that is selected. The temperature in the hydrogen production unit 325 is preferably 25-46° C.

The hydrogen exits the hydrogen production unit 325 via an HPU outlet 340. The hydrogen is preferably at 25-46° C., 10-50 bar, as high as 99.995% pure but preferably 99.999%, and at a dew point of 5 ppm or less. The hydrogen then enters a hydrogen expansion tank 355. The hydrogen expansion tank 355 can be any size but preferably has a volume of 0.5 to 2 m³. The hydrogen expansion tank 355 may contain phosphorus pentoxide to dry the hydrogen and may also comprise an accumulator and bladder hydraulic system to maintain a pressure between 10 to 50 bar. Once needed, the hydrogen exits the hydrogen expansion tank 355 via a nitrogen expansion tank outlet 360. The pressure of the hydrogen can be regulated via pressure regulators.

The nitrogen exiting the expansion tank 245 via the nitrogen expansion tank outlet 250 and the hydrogen exiting the hydrogen expansion tank 355 via the nitrogen expansion tank outlet 360 both enter a nitrogen and hydrogen input 401 at 20-30° C. and 10-50 bar. The expansion tank 245 and the hydrogen expansion tank 355 can be used to control the inflow of gases into the nitrogen and hydrogen input 401 at a stoichiometric ratio of 1 mole of nitrogen gas for every 3 moles of hydrogen gas. This ratio is close to optimal, but other ratios are possible. Different ratios will yield different amounts. A reactant mixture of the molar ratio of 1 mole of nitrogen gas for every 3 moles of hydrogen gas can be obtained through the usage of mass flow controllers and solenoid valves. A nitrogen mass flow controller may control the flow rate of nitrogen, and a hydrogen mass flow controller may control the hydrogen flow rate.

The reactant mixture of hydrogen and nitrogen with the appropriate molar ratio enters a mixed gas booster. The gas booster increases the reactant mixture pressure from approximately 4 to 30 bar (preferably 25 to 30 bar) to around 80-280 bar, preferably 145 bar plus or minus 10 bar (more preferably 135 to 150 bar). However, the pressure is not particularly limited and may be any suitable pressure based on the type of other components chosen in the system. The gas booster can also be replaced with a mixed gas compressor to compress the mixed hydrogen and nitrogen at high pressure. A mixed gas compressor will also eliminate the need for a compressed air storage tank from the system of the present invention.

The mixed gas then exits the gas booster via a mixed gas booster outlet 404 wherein pressure and flow can be controlled via regulator valve and mass flow controllers, respectively. The mixed gas then enters a three-way valve, which is connected to a reactor 440 via an inlet 407 and to a reactor 480 via an inlet 406. The mixed gas in inlet 407 then enters the reactor 440 via a reactor inlet 423. The mixed gas in inlet 406 enters the reactor 480 via a reactor inlet 442.

The reactors 440 and 480 may be any desired size but preferably have a volume of 0.008 to 0.8 m³ (preferably at a range of 0.008 to 0.1 m³) and are tubular in shape. The reactors 440 and 480 are preferably made from a 316 stainless steel material or other suitable material with the size being determined by the process rate desired. To process 100 kg per day output, the reactors can have a length of approximately 1 to 2 meters and a diameter of approximately 10 to 20 centimeters. The reactors contain a catalyst. The catalyst beds are axial radial cylindrical baskets with open screen top that can be inserted into a capsule. The capsule separates the catalyst basket from the pressure vessel walls (for cooling and even heat transfer along the walls). Radial flow is preferred with an open top configuration reactor. The capsule simplifies the operation of loading and unloading the catalyst. The catalyst is very sensitive to oxygen and requires careful consideration when loading it into the system. Thus, using the mentioned design descriptions, the catalyst can be loaded outside the system in the right conditions (nitrogen atmosphere for example, sieved to remove any dust and loaded by dense loader to ensure uniformity across the beds) and can be transferred and inserted into the reactors. The maintenance is performed after about 25 years due to aging and inactivity.

Furthermore, the temperatures and pressures inside the reactors 440 and 480 may be recorded through temperature and pressure sensors. The reactors 440 and 480 may be covered with an electric furnace that utilizes electricity and heating coils to produce thermal energy, which is transferred to the reactor according to the required reaction conditions. This thermal energy can be used during startup and catalyst activation. The ammonia synthesis process is exothermic in nature, and as ammonia is produced, the heat generated is used to maintain the reactors 440 and 480 at high reaction temperatures. The reactors 440 and 480 are filled with an ammonia synthesis catalyst, such as a magnetite based commercial catalyst, that aids in the synthesis process. There are several possible catalysts commercially available. Lower synthesis pressure and temperature are desirable for energy savings and can be achieved with catalysts that can operate under low temperature and pressure. For example, promoters added to an iron oxide catalyst show great improvement in the catalyst structure and performance under a range of different operating temperatures and pressures. Also, non-ferrous catalysts such as ruthenium catalysts promoted with MgAl₂O₄, Al₂O₃, MgO, and different mixtures of cesium and barium are shown to be effective for low temperature and pressure ammonia synthesis. These contributed to the commercialization of the ammonia process that are known, such as the KAAP process and the KBR process.

The ammonia and the unreacted hydrogen and nitrogen gases exit the reactor 440 via a reactor outlet 441 and then are mixed and quenched with the fresh feed stream 406 before entering the reactor 480 via the reactor inlet 442. The quench process may lower the reactant temperature by 10 to 40° C. (preferably at a range of 10-20° C.) without the requirement of a heat exchanger.

The ammonia and the unreacted hydrogen and nitrogen gases exit the reactor 480 via a reactor outlet 485, wherein pressure and flow can be controlled via regulator valve and mass flow controllers, respectively, and enter a cooling coil 495. The shape and size of the cooling coil 495 can vary but is preferably a helical coil. The cooling coil 495 drops the temperature of the ammonia and the unreacted hydrogen and nitrogen gases to 50-200° C. The ammonia and the unreacted hydrogen and nitrogen gases then exit the cooling coil 495 via a cooling coil outlet 500 and enter a condenser 510.

The condenser 510 may be an air chiller, a water chiller, or a refrigerant-based chiller and may have a surface area of 0.1-0.8 m² (preferably at a range of 0.1 to 0.5 m²). The condenser 510 includes a condenser component inlet 540 wherein a refrigerant can enter a chiller 550 and then exit the chiller 550 via a condenser component outlet 560. The refrigerant can be air, water, or other refrigerants (e.g., R134A, R33, etc.). The chiller 550 may use vapor compression or vapor absorption cooling cycles. Vapor compression cycles operate with electrical input. Vapor absorption cycles operate with heat input. The pressures and temperatures of the refrigerants in the condenser component outlet 560 will depend on the type of the refrigerants used but are preferably −20 to −5° C. (more preferably at a range of −10 to −5° C.) and 5 to 10 bar. The pressures and temperatures of the refrigerants in the condenser component inlet 540 will also depend on the type of the refrigerants used but are preferably −5 to 1° C. and 1 to 5 bar.

The condenser 510 separates the ammonia produced from the unreacted hydrogen and nitrogen gases. Since the synthesis reactor 480 is operated at a high pressure of approximately 80-280 bar, preferably 145 bar plus or minus 10 bar, the produced ammonia is condensed through the condenser 510. However, the pressure is not particularly limited and may be any suitable pressure based on the type of other components chosen in the system. As the condensation temperature of ammonia increases with pressure, it is liquefied in the condenser 510 that entails partial pressures of ammonia according to the conversion rates. The liquid ammonia separates from the mixture and settles down in a separator 620 via a separator inlet 600. The remaining unreacted hydrogen and nitrogen gases are recycled and sent back to the reactor 440 via an unreacted gas outlet 422. Since the unreacted hydrogen and nitrogen gases are at a higher pressure than the reactor 440, the gases can be recycled without requiring another gas compressor. Thus, through this new methodology, the unreacted gases are recycled, and the ammonia produced is separated without the requirement of an additional refrigeration system.

The separator 620 may be a flash drum with a volume of 0.005 to 0.5 m³ (preferably at a range of 0.005 to 0.05 m³). The ammonia then exits the separator 620 via a separator outlet 650 to a storage unit. The outlet pressure of the separator 620 can be varied via a regulator valve according to the required storage pressure. To account for any pressure drop across all equipment, a recirculation pump/booster 635 may be used to boost the pressure of the unreacted gases and residual ammonia to the ideal reaction pressure preferably between 80 and 280 bar.

A power generation and storage unit 800 provides power to any system components that need electricity. The unit 800 can use any source of power, including renewable energy resources such as wind, solar, tidal, geothermal, and hydropower. System components requiring electrical inputs include the HPU 325 via an electrical input 840, the NPU 225 via an electrical input 810, the air compression and storage unit 210 via an electrical input 820, the water treatment and storage unit 310 via an electrical input 850, the reactor 480 via an electrical input 460, and the reactor 440 via an electrical input 870. These components may be connected with electrical connections to form one connection that can be used to power the system. Hence, the modular anhydrous ammonia producer can be conveniently transported to any location having an electrical supply and can be connected to produce anhydrous ammonia.

Another embodiment of the present invention is shown in FIG. 4, which provides a parallel reactor configuration. This configuration entails a parallel reactor operation where the booster exit is connected to the inlets of both reactors. This operational configuration allows the distribution of reactant gases into two parallel reactors, hence, decreasing the volumetric flow rate through each reactor and increasing the residence time in each reactor. As the residence time increases, the rate of ammonia synthesis in each reactor also rises.

Similar to FIG. 3, an air inlet 200 allows air (preferably at room temperature and atmospheric pressure) to enter an air compression and storage unit 210. The air compression and storage unit 210 intakes the atmospheric air and pressurizes it. The air compression and storage unit 210 can store air at a high pressure, preferably at 10 to 100 bar, more preferably at a range of 70 to 100 bar. The air can then be regulated to a lower pressure as required. For example, the air can be used at 4-30 bar, preferably 4-5 bar. This pressure is required to conduct an adsorption process followed by desorption processes. The compression and storage unit 210 may be a reciprocating compressor or a screw compressor. The air compression and storage unit 210 pressurizes atmospheric air and sends it to a nitrogen production unit (NPU) 225 via an inlet 220. The inlet 220 provides air to the NPU 225 at a regulated pressure, preferably 3-6 bar. The NPU 225 provides adsorption-based separation of oxygen and nitrogen from air. The adsorbents may be carbon molecular sieves, zeolites, or other suitable adsorbents. For example, the NPU 225 may include an enclosed container filled with carbon molecular sieves. The pressurized atmosphere within the container, and the presence of molecular sieves allow the adsorption of oxygen molecules from the air. Thus, once the oxygen molecules are adsorbed, the remaining nitrogen molecules are allowed to exit the container and enter another enclosed compartment. The nitrogen exits the NPU 225 via an NPU outlet 240 and enters an expansion tank 245. The nitrogen in the NPU outlet 240 is preferably at 26-46° C., 10-50 bar, as high as 99.995% pure but preferably 99.999%, and at a dew point of 5 ppm or less. The nitrogen in the expansion tank 245 cools slightly, preferably to 25-40° C. The expansion tank 245 can be any size but preferably has a volume of 0.5 to 2 m³. The expansion tank 245 may contain sieve molecules to dry the nitrogen and may also comprise an accumulator and bladder hydraulic system to maintain a pressure between 10 to 50 bar. Once needed, the nitrogen exits the expansion tank 245 via a nitrogen expansion tank outlet 250.

A water inlet 300 allows water (preferably at room temperature and 3-5 bar) to enter a water treatment and storage unit 310. The water may be pure water. The water may also be brine, sea water, saline water, or wastewater if a water treatment process is integrated with the system. As such, the water treatment and storage unit 310 may include a reverse osmosis process, brine purification, or a wastewater treatment process. The water then exits the water treatment and storage unit 310 via a water treatment and storage unit outlet 320, preferably at a temperature of 30-60° C. and a pressure of 3-5 bar, and enters a hydrogen production unit (HPU) 325 that generates onboard hydrogen. The hydrogen production unit 325 may be a proton exchange membrane (PEM), alkaline, photoelectrochemical, CuCl, or MgCl₂ based hydrogen production process wherein a hydrogen purity preferably of 99.999% can be achieved.

The hydrogen production unit 325 may be utilized with a unique methodology in the system of the present invention wherein water is first preheated through the utilization of waste heat. Increasing the temperature of input water to the hydrogen production unit 325 aids in enhancing the hydrogen production rates as well as the overall system efficiencies. Thus, a new water circulating design that provides cooling to the air compression and storage unit 210 and acts as the input to the hydrogen production unit 325 to enhance hydrogen production during ammonia synthesis may be employed. The hydrogen production unit 325 is preferably a high-pressure PEM electrolyser that can introduce hydrogen gas in the system at a pressure of 5-50 bar (preferably 10-50 bar), but the exact pressure is determined by the rated output of the type of electrolyser that is selected. The temperature in the hydrogen production unit 325 is preferably 25-46° C.

The hydrogen exits the hydrogen production unit 325 via an HPU outlet 340. The hydrogen is preferably at 25-46° C., 10-50 bar, as high as 99.995% pure, and at a dew point of 5 ppm or less. The hydrogen then enters a hydrogen expansion tank 355. The hydrogen expansion tank 355 can be any size but preferably has a volume of 0.5 to 2 m³. The hydrogen expansion tank 355 may also contain phosphorus pentoxide to dry the hydrogen. Once needed, the hydrogen exits the hydrogen expansion tank 355 via a nitrogen expansion tank outlet 360. The pressure of the hydrogen can be regulated via pressure regulators.

The nitrogen exiting the expansion tank 245 via the nitrogen expansion tank outlet 250 and the hydrogen exiting the hydrogen expansion tank 355 via the nitrogen expansion tank outlet 360 both enter a mixed gas booster inlet 401 at 20-30° C. and 10-50 bar. The expansion tank 245 and the hydrogen expansion tank 355 can be used to control the inflow of gases into the mixed gas booster inlet 401 at a stoichiometric ratio of 1 mole of nitrogen gas for every 3 moles of hydrogen gas. This ratio is close to optimal, but other ratios are possible. Different ratios will yield different amounts. A reactant mixture of the molar ratio of 1 mole of nitrogen gas for every 3 moles of hydrogen gas can be obtained through the usage of mass flow controllers and solenoid valves. A nitrogen mass flow controller may control the flow rate of nitrogen, and a hydrogen mass flow controller may control the hydrogen flow rate.

The reactant mixture of hydrogen and nitrogen with the appropriate molar ratio enters a mixed gas booster. The gas booster increases the reactant mixture pressure from approximately 4 to 30 bar (preferably 25 to 30 bar) to around 80-280 bar, preferably 145 bar plus or minus 10 bar (more preferably 135 to 150 bar). However, the pressure is not particularly limited and may be any suitable pressure based on the type of other components chosen in the system. The gas booster can also be replaced with a mixed gas compressor to compress the mixture of hydrogen and nitrogen at high pressure. A hydrogen compressor will also eliminate the need for a compressed air storage tank from the system of the present invention.

The mixed gas then exits the gas booster via a mixed gas booster outlet 405 wherein pressure and flow can be controlled via regulator valve and mass flow controllers, respectively. The mixed gas then enters a three-way valve via an inlet 425. The mixed gas can then enter a reactor 440 via a reactor inlet 435 or can enter a reactor 480 via a reactor inlet 430.

The reactors 440 and 480 may be any desired size but preferably have a volume of 0.008 to 0.8 m³ (more preferably at a range of 0.008 to 0.1 m³) and are tubular in shape. The reactors 440 and 480 are preferably made from a 316 stainless steel material or other suitable material with the size being determined by the process rate desired. To process 100 kg per day output, the reactors can have a length of approximately 1 to 2 meters and a diameter of approximately 10 to 20 centimeters. The reactors contain a catalyst. The catalyst beds are axial radial cylindrical baskets with open screen top that can be inserted into a capsule. The capsule separates the catalyst basket from the pressure vessel walls (for cooling and even heat transfer along the walls). Radial flow is preferred with an open top configuration reactor. The capsule simplifies the operation of loading and unloading the catalyst. The catalyst is very sensitive to oxygen and requires careful consideration when loading it into the system. Thus, using the mentioned design descriptions, the catalyst can be loaded outside the system in the right conditions (nitrogen atmosphere for example, sieved to remove any dust and loaded by dense loader to ensure uniformity across the beds) and can be transferred and inserted into the reactors. The maintenance is performed after about 25 years due to aging and inactivity.

Furthermore, the temperatures and pressures inside the reactors 440 and 480 may be recorded through temperature and pressure sensors. The reactors 440 and 480 may be covered with an electric furnace that utilizes electricity and heating coils to produce thermal energy, which is transferred to the reactor according to the required reaction conditions. This thermal energy can be used during startup and catalyst activation. The ammonia synthesis process is exothermic in nature, and as ammonia is produced, the heat generated is used to maintain the reactors 440 and 480 at high reaction temperatures. The reactors 440 and 480 are filled with an ammonia synthesis catalyst, such as a magnetite based commercial catalyst, that aids in the synthesis process. There are several possible catalysts commercially available. Lower synthesis pressure and temperature are desirable for energy savings and can be achieved with catalysts that can operate under low temperature and pressure. For example, promoters added to an iron oxide catalyst show great improvement in the catalyst structure and performance under a range of different operating temperatures and pressures. Also, non-ferrous catalysts such as ruthenium catalysts promoted with MgAl₂O₄, Al₂O₃, MgO, and different mixtures of cesium and barium are shown to be effective for low temperature and pressure ammonia synthesis. These contributed to the commercialization of the ammonia process that are known, such as the KAAP process and the KBR process.

The ammonia and the unreacted hydrogen and nitrogen gases exit the reactor 440 via a reactor outlet 445 and exit the reactor 480 via a reactor outlet 465. The ammonia and the unreacted hydrogen and nitrogen gases in the reactor outlets 445 and 465 then combine in a three-way valve and through an outlet 466. The ammonia and the unreacted hydrogen and nitrogen gases then enter a cooling coil 495. The shape and size of the cooling coil 495 can vary but is preferably a helical coil. The cooling coil 495 drops the temperature of the ammonia and the unreacted hydrogen and nitrogen gases to 50-200° C. The ammonia and the unreacted hydrogen and nitrogen gases then exit the cooling coil 495 via a cooling coil outlet 500 and enter a condenser 510.

The condenser 510 may be an air chiller, a water chiller, or a refrigerant-based chiller and may have a surface area of 0.1-0.8 m² (more preferably at a range of 0.1 to 0.5 m²). The condenser 510 includes a condenser component inlet 540 wherein a refrigerant can enter a chiller 550 and then exit the chiller 550 via a condenser component outlet 560. The refrigerant can be air, water, or other refrigerant (e.g., R134A, R33, etc.). The chiller 550 may use vapor compression or vapor absorption cooling cycles. Vapor compression cycles operate with electrical input. Vapor absorption cycles operate with heat input. The pressures and temperatures of the refrigerants in the condenser component outlet 560 will depend on the type of the refrigerants used but are preferably −20 to −5° C. (more preferably at a range of −10 to −5° C.) and 5 to 10 bar. The pressures and temperatures of the refrigerants in the condenser component inlet 540 will also depend on the type of the refrigerants used but are preferably −5 to 1° C. and 1 to 5 bar.

The condenser 510 separates the ammonia produced from the unreacted hydrogen and nitrogen gases. Since the synthesis reactor 480 is operated at a high pressure of approximately 80-280 bar, preferably 145 bar plus or minus 10 bar, the produced ammonia is condensed through the condenser 510. However, the pressure is not particularly limited and may be any suitable pressure based on the type of other components chosen in the system. As the condensation temperature of ammonia increases with pressure, it is liquefied in the condenser 510 that entails partial pressures of ammonia according to the conversion rates. The liquid ammonia separates from the mixture and settles down in a separator 620 via a separator inlet 600. The remaining unreacted hydrogen and nitrogen gases are recycled and sent back to the inlet 425 via an unreacted gas outlet 421. Since the unreacted hydrogen and nitrogen gases are at a higher pressure than the reactors 440 and 480, the gases can be recycled without requiring another gas compressor. Thus, through this new methodology, the unreacted gases are recycled, and the ammonia produced is separated without the requirement of an additional refrigeration system.

The separator 620 may be a flash drum with a volume of 0.005 to 0.5 m³ (more preferably at a range of 0.005 to 0.05 m³). The ammonia then exits the separator 620 via a separator outlet 650 to a storage unit. The outlet pressure of the separator 620 can be varied via a regulator valve according to the required storage pressure. To account for any pressure drop across all equipment, a recirculation pump/compressor 635 may be used to boost the pressure of the unreacted gases and residual ammonia to the ideal reaction pressure preferably between 80 and 280 bar.

A power generation and storage unit 800 provides power to any system components that need electricity. The unit 800 can use any source of power, including renewable energy resources such as wind, solar, tidal, geothermal, and hydropower. System components requiring electrical inputs include the HPU 325 via an electrical input 840, the NPU 225 via an electrical input 810, the air compression and storage unit 210 via an electrical input 820, the water treatment and storage unit 310 via an electrical input 850, the reactor 480 via an electrical input 460, and the reactor 440 via an electrical input 870. These components may be connected with electrical connections to form one connection that can be used to power the machine. Hence, the modular ammonia producer can be conveniently transported to any location having an electrical supply and can be connected to produce ammonia.

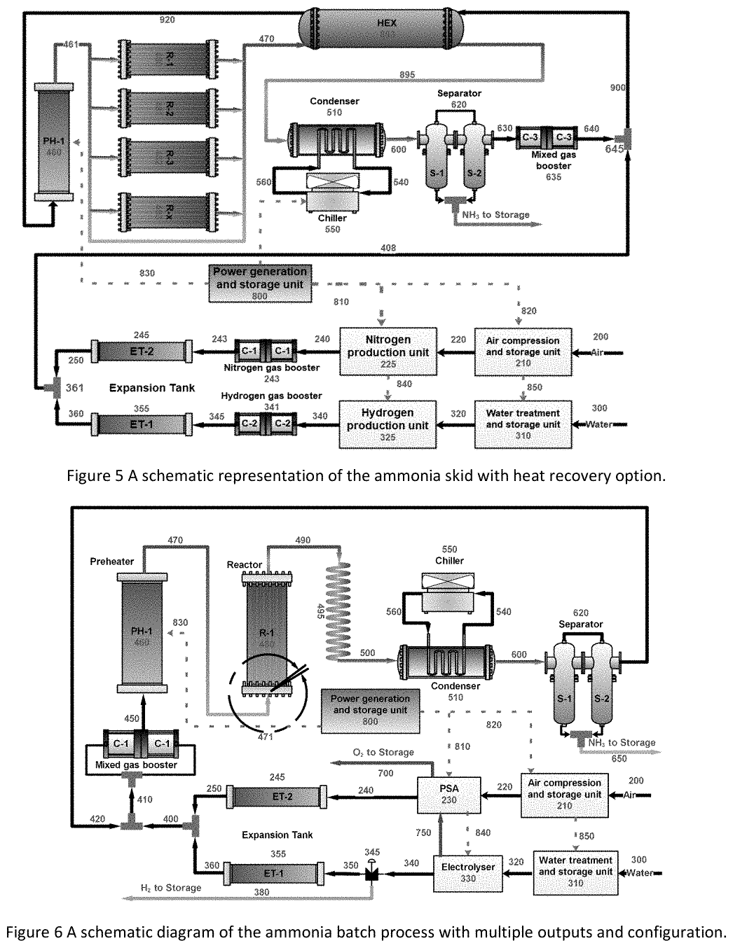

Another embodiment of the present invention is shown in FIG. 5.

An air inlet 200 allows air (preferably at room temperature and atmospheric pressure) to enter an air compression and storage unit 210. The air compression and storage unit 210 intakes the atmospheric air and pressurizes it. The air compression and storage unit 210 can store air at a high pressure, preferably at 10 to 100 bar, more preferably at a range of 70 to 100 bar. The air can then be regulated to a lower pressure as required. For example, the air can be used at 4-30 bar, preferably 4-5 bar. This pressure is required to conduct an adsorption process followed by desorption processes. The compression and storage unit 210 may be a reciprocating compressor or a screw compressor. The air compression and storage unit 210 pressurizes atmospheric air and sends it to a nitrogen production unit (NPU) 225 via an inlet 220. The inlet 220 provides air to the NPU 225 at a regulated pressure, preferably 3-6 bar. The NPU 225 provides adsorption-based separation of oxygen and nitrogen from air. The adsorbents may be carbon molecular sieves, zeolites, or other suitable adsorbents. For example, the NPU 225 may include an enclosed container filled with carbon molecular sieves. The pressurized atmosphere within the container and the presence of molecular sieves allow the adsorption of oxygen molecules from the air. Thus, once the oxygen molecules are adsorbed, the remaining nitrogen molecules are allowed to exit the container and enter another enclosed compartment. The nitrogen exits the NPU 225 via an NPU outlet 240 and enters the nitrogen compression unit 243. The nitrogen compression unit 243 intakes the compressed nitrogen and further pressurizes the nitrogen to a higher pressure approximately 80 to 280 bar. The nitrogen compression unit 243 may be a reciprocating compressor, a screw compressor or an air driven nitrogen gas booster. The nitrogen in the NPU outlet 240 is preferably at 26-46° C., 10-50 bar, as high as 99.995% pure, and at a dew point of 5 ppm or less. The pressurized nitrogen in the nitrogen compression unit 243 is then stored in the expansion tank 245 at a preferred temperature range of 25 to 40° C. The expansion tank 245 can be any size but preferably has a volume of 0.5 to 2 m³. The expansion tank 245 may contain sieve molecules to dry the nitrogen and may also comprise an accumulator and bladder hydraulic system to maintain a pressure between 80 to 280 bar. Once needed, the nitrogen exits the expansion tank 245 via a nitrogen expansion tank outlet 250.

A water inlet 300 allows water (preferably at a room temperature and a pressure range of 3 to 5 bar) to enter a water treatment and storage unit 310. The water may be pure water. The water may also be brine, sea water, saline water, or wastewater if a water treatment process is integrated with the system. As such, the water treatment and storage unit 310 may include a reverse osmosis process, brine purification, or a wastewater treatment process. The water then exits the water treatment and storage unit 310 via a water treatment and storage unit outlet 320, preferably at a temperature of 30-60° C. and a pressure of 3-5 bar, and enters a hydrogen production unit (HPU) 325 that generates onboard hydrogen. The hydrogen production unit 325 may be a proton exchange membrane (PEM), alkaline, photoelectrochemical, CuCl, or MgCl₂ based hydrogen production process wherein a hydrogen purity of 99.995% can be achieved.

The hydrogen production unit 325 may be utilized with a unique methodology in the system of the present invention wherein water is first preheated through the utilization of waste heat. Increasing the temperature of input water to the hydrogen production unit 325 aids in enhancing the hydrogen production rates as well as the overall system efficiencies. Thus, a new water circulating design that provides cooling to the air compression and storage unit 210 and acts as the input to the hydrogen production unit 325 to enhance hydrogen production during ammonia synthesis may be employed. The hydrogen production unit 325 is preferably a high pressure PEM electrolyser that can introduce hydrogen gas in the system at a pressure of 2-50 bar (preferably 5-50 bar, more preferably at a range of 10 to 50 bar), but the exact pressure is determined by the rated output of the type of electrolyser that is selected. The temperature in the hydrogen production unit 325 is preferably 25-46° C.

The hydrogen exits the hydrogen production unit 325 via an HPU outlet 340. The hydrogen is preferably at 25-46° C., 10-50 bar, as high as 99.995% pure, and at a dew point of 5 ppm or less. The hydrogen then enters a hydrogen compression unit 341. The hydrogen compression unit 341 intakes the compressed hydrogen and further pressurizes the hydrogen to a higher pressure of approximately 80 to 280 bar. The hydrogen compression unit 341 may be a reciprocating compressor, a screw compressor, or an air driven hydrogen gas booster. The hydrogen exiting the hydrogen compression unit 341 via the hydrogen compression outlet 345 is then stored in the hydrogen expansion tank 355. The hydrogen expansion tank 355 can be any size but preferably has a volume of 0.5 to 2 m³. The hydrogen expansion tank 355 may contain phosphorus pentoxide to dry the hydrogen and may also comprise an accumulator and bladder hydraulic system to maintain a pressure between 80 to 280 bar. Once needed, the hydrogen exits the hydrogen expansion tank 355 via a hydrogen expansion tank outlet 360. The pressure of the hydrogen can be regulated via pressure regulators.

The nitrogen exiting the expansion tank 245 via the nitrogen expansion tank outlet 250 and the hydrogen exiting the hydrogen expansion tank 355 via the hydrogen expansion tank outlet 360 both are blended in a static mixer 361 preferably at an approximate temperature of 25 to 40° C. and approximate pressure of 80-280 bar. The nitrogen expansion tank 245 and the hydrogen expansion tank 355 can be used to control the inflow of gases into the nitrogen and hydrogen input 408 at a stoichiometric ratio of 1 mole of nitrogen gas for every 3 moles of hydrogen gas. This ratio is close to optimal, but other ratios are possible. Different ratios will yield different amounts. A reactant mixture of the molar ratio of 1 mole of nitrogen gas for every 3 moles of hydrogen gas can be obtained through the usage of mass flow controllers and solenoid valves. A nitrogen mass flow controller may control the flow rate of nitrogen, and a hydrogen mass flow controller may control the hydrogen flow rate.

The reactant mixture of hydrogen and nitrogen are then blended in a static mixer 645 with the unreacted gas at the exit 640 of the mixed gas booster 635 with the appropriate molar ratio, enters a heat exchanger 893. The heat exchanger 893 may have an upstream 900 temperature of approximately 5 to 80° C. and a pressure of approximately 80 to 280 bar and may have a downstream 470 temperature of approximately 200 to 500° C. and a pressure of approximately 80 to 280 bar. Also the heat exchanger 893 may be designed as a single heat exchanger or multiple heat exchangers connected in the most optimal way to recover heat from the output of the reactor assembly.

The mixed gas then exits the heat exchanger 893 via a heat exchanger outlet 920 wherein pressure and flow can be controlled via regulator valve and mass flow controllers, respectively. The mixed gas then enters a preheater 460, which is equipped with electric heaters between 10 to 100 kW (preferably at a range of 10 to 40 kW), via a preheater inlet 920. The preheater 460 may be any desired size but preferably has a volume of 0.008 to 0.8 m³ (more preferably at a range of 0.008 to 0.1 m³) and is tubular in shape. The preheater 460 may be made from stainless steel or other preferred material that may support high temperatures. The preheater 460 increases the temperature and pressure of the mixed gas, preferably to 250-450° C. and 80-280 bar (more preferably at a range of 100-280 bar). The preferred operating temperature for the gases exiting the preheater 460 is 300° C. plus or minus 10° C. However, the temperature and pressure are not particularly limited and may be any suitable temperature and pressure based on the type of other components chosen in the system. The heated mixed gas then exits the preheater 460 via a preheater outlet 461, wherein pressure and flow can be controlled via regulator valve and mass flow controllers, respectively, and enters an ammonia reactor assembly 480-483.

The ammonia reactor assembly 480-483 may be any desired size but preferably has a volume of 0.008 to 0.8 m³ (more preferably at a range of 0.008 to 0.1 m³) and is tubular in shape. The reactor 480 is preferably made from a 316 stainless steel material or other suitable material with the size being determined by the process rate desired. The multi-reactor assembly can be a set of reactors for example R-1, R-2, R-3, to R-x joint in series or in parallel suitable to control the production and maximize the yield of ammonia. To operate on different loads, meaning turning on and off or varying the load of the system, requires a set of reactors that can respond quickly to the variation. The problem arises from the gas-to-gas heat transfer inside the reactor. To have fast response, the heat transfer of the reactor must be designed with fast response to heating. The dimensions of the reactor depend on the catalyst loading, reaction rate, temperature and pressure and concentration of reactants. Ideally small reactors are favorable for catalyst synthesis because of their high wall-to-volume ratio however they suffer from small volume processing. Thus, the term multiple reactor assembly includes a set number of small reactors where the production rate of ammonia is largely dependent on the number of reactors assembled together. To process 100 kg per day output, the reactor can have a length of approximately 1 to 2 meters and a diameter of approximately 10 to 20 centimeters. The reactor contains a catalyst. The catalyst beds are axial radial cylindrical baskets with open screen top that can be inserted into a capsule. The capsule separates the catalyst basket from the pressure vessel walls (for cooling and even heat transfer along the walls). Radial flow is preferred with an open top configuration reactor. The capsule simplifies the operation of loading and unloading the catalyst. The catalyst is very sensitive to oxygen and requires careful consideration when loading it into the system. Thus, using the mentioned design descriptions, the catalyst can be loaded outside the system in the right conditions (nitrogen atmosphere for example, sieved to remove any dust and loaded by dense loader to ensure uniformity across the beds) and can be transferred and inserted into the reactor. The maintenance is performed after about 25 years due to aging and inactivity.

Furthermore, the temperatures and pressures inside the reactor assembly 480-483 may be recorded through temperature and pressure sensors. The reactor assembly 480-483 may be covered with an electric furnace that utilizes electricity and heating coils to produce thermal energy, which is transferred to the reactor according to the required reaction conditions. This thermal energy can be used during startup and catalyst activation. The ammonia synthesis process is exothermic in nature, and as ammonia is produced, the heat generated is used to maintain the reactor assembly 480-483 at high reaction temperatures. The reactors R-1, R-2, R-3 and R-x are filled with an ammonia synthesis catalyst, such as a magnetite based commercial catalyst, that aids in the synthesis process. There are several possible catalysts commercially available. Lower synthesis pressure and temperature are desirable for energy savings and can be achieved with catalysts that can operate under low temperature and pressure. For example, promoters added to an iron oxide catalyst show great improvement in the catalyst structure and performance under a range of different operating temperatures and pressures. Also, non-ferrous catalysts such as ruthenium catalysts promoted with MgAl₂O₄, Al₂O₃, MgO, and different mixtures of cesium and barium are shown to be effective for low temperature and pressure ammonia synthesis. These contributed to the commercialization of the ammonia process that are known, such as the KAAP process and the KBR process.

The ammonia and the unreacted hydrogen and nitrogen gases exit the reactor assembly 480-483 via a reactor assembly outlet 470 at a temperature of 250-450° C., wherein pressure and flow can be controlled via regulator valve and mass flow controllers, respectively, and enter a heat exchanger 893. The ammonia and the unreacted hydrogen and nitrogen gases exit the heat exchanger 893 via a heat exchanger outlet 895 at temperature of 50-100° C. and enter a condenser 510.

The condenser 510 may be an air chiller, a water chiller, or a refrigerant-based chiller and may have a surface area of 0.1-0.8 m² (more preferably at a range of 0.1 to 0.5 m²). The condenser 510 includes a condenser component inlet 540 wherein a refrigerant can enter a chiller 550 and then exit the chiller 550 via a condenser component outlet 560. The refrigerant can be air, water, or other refrigerants (e.g., R134A, R33, etc.). The chiller 550 may use vapor compression or vapor absorption cooling cycles. Vapor compression cycles operate with electrical input. Vapor absorption cycles operate with heat input. The pressures and temperatures of the refrigerants in the condenser component outlet 560 will depend on the type of the refrigerants used but are preferably −20 to −5° C. (more preferably at a range of −10 to −5° C.) and 5 to 10 bar. The pressures and temperatures of the refrigerants in the condenser component inlet 540 will also depend on the type of the refrigerants used but are preferably −5 to 1° C. and 1 to 5 bar.

The condenser 510 separates the ammonia produced from the unreacted hydrogen and nitrogen gases. Since the synthesis reactor assembly 480-483 is operated at a high pressure of approximately 80-280 bar, preferably 145 bar plus or minus 10 bar, the produced ammonia is condensed through the condenser 510. However, the pressure is not particularly limited and may be any suitable pressure based on the type of other components chosen in the system. As the condensation temperature of ammonia increases with pressure, it is liquefied in the condenser 510 that entails partial pressures of ammonia according to the conversion rates. The liquid ammonia separates from the mixture and settles down in a separator 620 via a separator inlet 600. The remaining unreacted hydrogen and nitrogen gases are recycled and sent back to the heat exchanger 893 via a heat exchanger inlet 900 at a temperature of −15-25° C. (more preferably at a range of −10 to 25° C.).

The separator 620 may be a flash drum with a volume of 0.005 to 0.5 m³ (more preferably at a range of 0.005 to 0.05 m³). The ammonia then exits the separator 620 via a separator outlet 630 to a storage unit. The outlet pressure of the separator 620 can be varied via a regulator valve according to the required storage pressure.

A power generation and storage unit 800 provides power to any system components that need electricity. The unit 800 can use any source of power, including renewable energy resources such as wind, solar, tidal, geothermal, and hydropower. System components requiring electrical inputs include the HPU 325 via an electrical input 840, the NPU 225 via an electrical input 810, the air compression and storage unit 210 via an electrical input 820, the preheater 460 via an electrical input 830, and the water treatment and storage unit 310 via an electrical input 850. These components may be connected with electrical connections to form one connection that can be used to power the machine. Hence, the modular ammonia producer can be conveniently transported to any location having an electrical supply and can be connected to produce ammonia.

Another embodiment of the present invention is shown in FIG. 6 with a batch process configuration.

Similar to FIG. 1, an air inlet 200 allows air (preferably at room temperature and atmospheric pressure) to enter an air compression and storage unit 210. The air compression and storage unit 210 intakes the atmospheric air and pressurizes it. The air compression and storage unit 210 can store air at a high pressure, preferably at 10 to 100 bar, more preferably at a range of 70 to 100 bar. The air can then be regulated to a lower pressure as required. For example, the air can be used at 4-30 bar, preferably 4-5 bar. This pressure is required to conduct an adsorption process followed by desorption processes. The compression and storage unit 210 may be a reciprocating compressor or a screw compressor. The air compression and storage unit 210 pressurizes atmospheric air and sends it to a PSA 230 via a PSA inlet 220. The PSA inlet provides air to the PSA 230 at a regulated pressure, preferably 3-6 bar. The PSA 230 provides adsorption-based separation of oxygen and nitrogen from air. The adsorbents may be carbon molecular sieves, zeolites, or other suitable adsorbents. For example, the PSA 230 may include an enclosed container filled with carbon molecular sieves. The pressurized atmosphere within the container and the presence of molecular sieves allow the adsorption of oxygen molecules from the air. Thus, once the oxygen molecules are adsorbed, the remaining nitrogen molecules are allowed to exit the container and enter another enclosed compartment. The oxygen adsorbed is allowed to desorb through a pressure swing that is produced by controlling the air compression and storage unit 210 via a time delay relay. The oxygen can then proceed via oxygen outlet 700 to be stored in a storage vessel. This oxygen can be used for emergency purposes, such as treatment of COVID-19. The nitrogen exits the PSA 230 via PSA outlet 240 and enters an expansion tank 245. The nitrogen in the PSA outlet 240 is preferably at 26-46° C., 10-50 bar, as high as 99.995% pure, and at a dew point of 5 ppm or less. The nitrogen in the expansion tank 245 cools slightly, preferably to 25-40° C. The expansion tank 245 can be any size but preferably has a volume of 0.5 to 2 m³. The expansion tank 245 may contain sieve molecules to dry the nitrogen and may also comprise an accumulator and bladder hydraulic system to maintain a pressure between 10 to 50 bar. Once needed, the nitrogen exits the expansion tank 245 via a nitrogen expansion tank outlet 250.

A water inlet 300 allows water (preferably at room temperature and 3-5 bar) to enter a water treatment and storage unit 310. The water may be pure water. The water may also be brine, sea water, saline water, or wastewater if a water treatment process is integrated with the system. As such, the water treatment and storage unit 310 may include a reverse osmosis process, brine purification, or a wastewater treatment process. The water then exits the water treatment and storage unit 310 via a water treatment and storage unit outlet 320, preferably at a temperature of 30-60° C. and a pressure of 3-5 bar and enters an electrolyser 330 that generates onboard hydrogen. In the electrolyser 330, water is dissociated electrochemically into oxygen and hydrogen gases. The electrolyser 330 may be a proton exchange membrane (PEM), anion exchange membrane (AEM), or alkaline.

The electrolyser or other such methods of producing hydrogen 330 may be utilized with a unique methodology in the system of the present invention wherein water is first preheated through the utilization of waste heat in the system such as the heat generated in the compressor. Increasing the temperature of input water to the electrolyser 330 aids in enhancing the hydrogen production rates as well as the overall system efficiencies. Thus, a new water circulating design that provides cooling to the air compression and storage unit 210 and acts as the input to the water electrolyser 330 to enhance hydrogen production during ammonia synthesis may be employed. The electrolyser 330 is preferably a high-pressure PEM electrolyser that can introduce hydrogen gas in the system at a pressure of 2-50 bar (more preferably at a range of 10 to 50 bar), but the exact pressure is determined by the rated output of the type of electrolyser that is selected. The temperature in the electrolyser 330 is preferably at a range of 25 to 46° C.

The oxygen produced in the electrolyser 330 exits via an oxygen outlet 750 to be stored in a storage vessel. This oxygen can be used for emergency purposes, such as treatment of COVID-19.

The hydrogen exits the electrolyser 330 via an electrolyser outlet 340. The hydrogen is preferably at 25-46° C., 10-50 bar, as high as 99.995% pure, and at a dew point of 5 ppm or less. The hydrogen then enters a three-way regulator valve 345, which controls the outlet pressure and flow based on requirements. The hydrogen needed for the process of the present invention exits the valve 345 via an outlet 350 of the three-way regulator valve 345 and enters a hydrogen expansion tank 355. The hydrogen expansion tank 355 can be any size but preferably has a volume of 0.05 to 0.1 m³. The hydrogen expansion tank 355 may contain phosphorus pentoxide to dry the hydrogen and may also comprise an accumulator and bladder hydraulic system to maintain a pressure between 10 to 50 bar. Once needed, the hydrogen exits the hydrogen expansion tank 355 via a hydrogen expansion tank outlet 360. The pressure of the hydrogen can be regulated via pressure regulators.

Any excess hydrogen can proceed via an outlet 380 of the three-way regulator valve 345 to be stored in a storage vessel.

The nitrogen exiting the expansion tank 245 via the nitrogen expansion tank outlet 250 and the hydrogen exiting the hydrogen expansion tank 355 via the hydrogen expansion tank outlet 360 both enter the nitrogen and hydrogen input 400 at 25-40° C. and 10-50 bar. The expansion tank 245 and the hydrogen expansion tank 355 can be used to control the inflow of gases into the nitrogen and hydrogen input 400 at a stoichiometric ratio of 1 mole of nitrogen gas for every 3 moles of hydrogen gas. This ratio is close to optimal, but other ratios are possible. Different ratios will yield different amounts. A reactant mixture of the molar ratio of 1 mole of nitrogen gas for every 3 moles of hydrogen gas can be obtained through the usage of mass flow controllers and solenoid valves. A nitrogen mass flow controller may control the flow rate of nitrogen, and a hydrogen mass flow controller may control the hydrogen flow rate.

The mixed gas of nitrogen and hydrogen then enter a mixed gas booster inlet 410 wherein pressure and flow can be controlled via regulator valve and mass flow controllers, respectively. Next, the reactant mixture of hydrogen and nitrogen with the appropriate molar ratio enters a mixed gas booster. The gas booster increases the reactant mixture pressure from approximately 4 to 30 bar (preferably 25 to 30 bar) to around 80-280 bar, preferably 145 bar plus or minus 10 bar (more preferably 135 to 150 bar). However, the pressure is not particularly limited and may be any suitable pressure based on the type of other components chosen in the system. The gas booster can also be replaced with a mixed gas compressor to compress the mixture of hydrogen and nitrogen at high pressure. A mixed gas compressor will also eliminate the need for a compressed air storage tank from the system of the present invention.

The mixed gas then exits the gas booster via a mixed gas booster outlet 450 wherein pressure and flow can be controlled via regulator valve and mass flow controllers, respectively. The mixed gas then enters a preheater 460, which is equipped with electric heaters between 10 to 100 kW (more preferably at a range of 10 to 40 kW). The preheater 460 may be any desired size but preferably has a volume of 0.008 to 0.8 m³ (more preferably at a range of 0.008 to 0.1 m³) and is tubular in shape. The preheater 460 increases the temperature and pressure of the mixed gas, preferably to 250-450° C. and 80-280 bar (more preferably at a range of 100 to 280 bar). The preferred operating temperature for the gases exiting the preheater 460 is 300° C. plus or minus 10° C. However, the temperature and pressure are not particularly limited and may be any suitable temperature and pressure based on the type of other components chosen in the system. The heated mixed gas then exits the preheater 460 via a preheater outlet 470, wherein pressure and flow can be controlled via regulator valve and mass flow controllers, respectively, and enters an ammonia reactor 480.

The ammonia reactor 480 may be any desired size but preferably has a volume of 0.008 to 0.8 m³ (more preferably at a range of 0.008 to 0.1 m³) and is tubular in shape. The reactor 480 is preferably made from a 316 stainless steel material or other suitable material with the size being determined by the process rate desired. To process 100 kg per day output, the reactor can have a length of approximately 1 to 2 meters and a diameter of approximately 10 to 20 centimeters. The reactor contains a catalyst. The catalyst beds are axial radial cylindrical baskets with open screen top that can be inserted into a capsule. The capsule separates the catalyst basket from the pressure vessel walls (for cooling and even heat transfer along the walls). Radial flow is preferred with an open top configuration reactor. The capsule simplifies the operation of loading and unloading the catalyst. The catalyst is very sensitive to oxygen and requires careful consideration when loading it into the system. Thus, using the mentioned design descriptions, the catalyst can be loaded outside the system in the right conditions (nitrogen atmosphere for example, sieved to remove any dust and loaded by dense loader to ensure uniformity across the beds) and can be transferred and inserted into the reactor. The maintenance is performed after about 25 years due to aging and inactivity.

Furthermore, the temperatures and pressures inside the reactor 480 may be recorded through temperature and pressure sensors. The reactor 480 may be covered with an electric furnace that utilizes electricity and heating coils to produce thermal energy, which is transferred to the reactor according to the required reaction conditions. This thermal energy can be used during startup and catalyst activation. The ammonia synthesis process is exothermic in nature, and as ammonia is produced, the heat generated is used to maintain the reactor 480 at high reaction temperatures. The reactor 480 is filled with an ammonia synthesis catalyst, such as a magnetite based commercial catalyst, that aids in the synthesis process. There are several possible catalysts commercially available. Lower synthesis pressure and temperature are desirable for energy savings and can be achieved with catalysts that can operate under low temperature and pressure. For example, promoters added to an iron oxide catalyst show great improvement in the catalyst structure and performance under a range of different operating temperatures and pressures. Also, non-ferrous catalysts such as ruthenium catalysts promoted with Magnesium and aluminium-based catalyst promoters (MgAl₂O₄, Al₂O₃, MgO), and different mixtures of cesium and barium are shown to be effective for low temperature and pressure ammonia synthesis. These contributed to the commercialization of the ammonia processes that are known, such as the KAAP process and the KBR process.

The reactor 480 may also include a reactor orientation device 471, which allows the reactor 480 to be rotated from 5 degrees to 360 degrees for better conversion efficiency.

The ammonia and the unreacted hydrogen and nitrogen gases exit the reactor 480 via a reactor outlet 490, wherein pressure and flow can be controlled via regulator valve and mass flow controllers, respectively, and enter a cooling coil 495. The shape and size of the cooling coil 495 can vary but is preferably a helical coil. The cooling coil 495 drops the temperature of the ammonia and the unreacted hydrogen and nitrogen gases to 50-200° C. The ammonia and the unreacted hydrogen and nitrogen gases then exit the cooling coil 495 via a cooling coil outlet 500 and enter a condenser 510.

The condenser 510 may be an air chiller, a water chiller, or a refrigerant-based chiller and may have a surface area of 0.1-0.8 m² (more preferably at a range of 0.1 to 0.5 m²). The condenser 510 includes a condenser component inlet 540 wherein a refrigerant can enter a chiller 550 and then exit the chiller 550 via a condenser component outlet 560. The refrigerant can be air, water, or other refrigerants (e.g., R134A, R33, etc.). The chiller 550 may use vapor compression or vapor absorption cooling cycles. Vapor compression cycles operate with electrical input. Vapor absorption cycles operate with heat input. The pressures and temperatures of the refrigerants in the condenser component outlet 560 will depend on the type of the refrigerants used but are preferably −20 to −5° C. (more preferably at a range of −10 to −5° C.) and 5 to 10 bar. The pressures and temperatures of the refrigerants in the condenser component inlet 540 will also depend on the type of the refrigerants used but are preferably −5 to 1° C. and 1 to 5 bar.

The condenser 510 separates the ammonia produced from the unreacted hydrogen and nitrogen gases. Since the synthesis reactor 480 is operated at a high pressure of approximately 80-280 bar, preferably 145 bar plus or minus 10 bar, the produced ammonia is condensed through the condenser 510. However, the pressure is not particularly limited and may be any suitable pressure based on the type of other components chosen in the system.

As the condensation temperature of ammonia increases with pressure, it is liquefied in the condenser 510 that entails partial pressures of ammonia according to the conversion rates. The liquid ammonia separates from the mixture and settles down in a separator 620 via a separator inlet 600. The remaining unreacted hydrogen and nitrogen gases are recycled and sent back to the mixed gas booster inlet 410 via an unreacted gas outlet 420. Since the unreacted hydrogen and nitrogen gases are at a higher pressure than the preheater 460, the gases can be recycled without requiring another gas compressor. Thus, through this new methodology, the unreacted gases are recycled, and the ammonia produced is separated without the requirement of an additional refrigeration system.

The separator 620 may be a flash drum with a volume of 0.005 to 0.5 m³, more preferably at a range of 0.005 to 0.05 m³. The ammonia then exits the separator 620 via a separator outlet 650 to a storage unit. The outlet pressure of the separator 620 can be varied via a regulator valve according to the required storage pressure.

A power generation and storage unit 800 provides power to any system components that need electricity. The unit 800 can use any source of power, including renewable energy resources such as wind, solar, tidal, geothermal, and hydropower. System components requiring electrical inputs include the electrolyser 330 via an electrical input 840, the PSA 230 via an electrical input 810, the air compression and storage unit 210 via an electrical input 820, the preheater 460 via an electrical input 830, and the water treatment and storage unit 310 via an electrical input 850. These components may be connected with electrical connections to form one connection that can be used to power the machine. Hence, the modular ammonia producer can be conveniently transported to any location having an electrical supply and can be connected to produce ammonia.

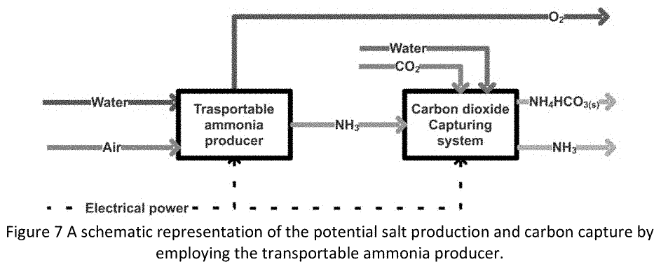

FIG. 7 provides a schematic representation of salt production and carbon capture by employing the transportable ammonia producer of the present invention. Specifically, water, air, and electrical power are input into the transportable ammonia producer of the present invention to generate oxygen and ammonia. Then, the produced ammonia, water, carbon dioxide, and electrical power can be input into a carbon dioxide capturing system to produce ammonia and NH₄HCO₃.

The electrical inputs for the system components of the present invention can be obtained via renewable energy resources such as solar and wind energy that will enable the developed ammonia producer to produce environmentally benign ammonia. Thus, the modular size ammonia-producing machine can synthesize environmentally benign ammonia. The system is designed to meet an ammonia production rate ranging from 50 kg/day to 1000 kg/day. The sizing of the system components is designed accordingly. However, larger or smaller size configurations are also possible, depending on how much ammonia needs to be produced.

Eventually the containerized system inputs are hydrogen and nitrogen and electrical power. For each mole of NH₃ (0.017 g), 1.5 mole of H₂ (0.003 g) are required. To assess the energy requirement for ammonia synthesis, hydrogen production is calculated based on 1 L of liquid NH₃ (0.698 kg) or 41.05 mols. Then the hydrogen requirement is found to be 61.575 mols (0.123 kg). To understand the electrical requirement needed for the hydrogen production, the electrolyser efficiency is taken at 100% current efficiency. This results in electrical input that is equal to the enthalpy change of water dissociation which is 142 MJ/kg of H₂ or 39.45 kWh for 1 kg of H₂. For the energy requirement for 1 liter of liquid NH₃ the electrolyser consumption is found to be 4.86 kWh. Also taking the practical efficiency at 50% then the electrolyser requirement is calculated to be 9.72 kWh. The energy efficiency of the power to ammonia system is taken based on the useful output and the input. The results are expressed in specific energy to produce 1 L of liquid ammonia (density=698 kg/m³). The energy consumption for a low temperature proton exchange membrane (PEM) electrolyser would require approximately 6.8 kWh/L NH₃.

For example, a typical fully automated 300 kg/day containerized system, utilizes three ISO 20 ft containers. The first container houses a water treatment device, an electrolyser, a hydrogen compression and storage system, buffer tanks, electrical wiring, gas piping, gas detection system, active ventilation, internal control and monitoring system, climate control system, partition zones, service doors, and safety and emergency system. Primarily, the system is supplied with power from a carbon free grid (such as solar, wind, or any carbon free source of power), via a direct connection to the nominal 400 VAC 3 Phase 50 or 60 Hz grid connected bus available at the project site. To operate the electrolyser, there is a requirement for a supply of pure water. A water treatment system is supplied within the hydrogen production system with an approximate capacity of 18 L/h. This produces pure water from the readily available water supply. During electrolysis both hydrogen and oxygen are produced inside the electrolyser. The expected hydrogen production capacity is approximately 2.62 kg/h stored at an approximate pressure of 150 bar. The second container houses an air compression and storage system, a nitrogen generator, a nitrogen compression and storage system, electrical wiring, gas piping, gas detection system, active ventilation, internal control and monitoring system, climate control system, partition zones, service doors, and safety and emergency system. The air flow requirement to produce nitrogen is approximately 120 Nm3/h delivered at a pressure of approximately 8 bar. The expected nitrogen production capacity is approximately 15 kg/h stored at an approximate pressure of 150 bar. The third container houses a gas mixing system, multi-reactor assembly, preheater, heat exchangers, chiller, condenser, separator, mixed gas boosting system, electrical wiring, gas piping, gas detection system, active ventilation, internal control and monitoring system, climate control system, partition zones, service doors, and safety and emergency system. The system is capable of operating between 20% and 100% capacity and the expected ammonia production is approximately 12.5 kg/h stored at an approximate pressure of 150 bar. A comprehensive and integrated control and monitoring (C&M) system is supplied for the system. The Control & Monitoring system uses a sensor for the gas equipment and is linked to the three containers for remote application such as turning on/off the system, maintenance, and optimization. The container assembly provides ease of transport and installation in remote areas and system operation in extreme weather conditions while protecting the hardware. Also, each container can operate independent of the other such that if one is being maintained then the other containers are not affected.

The gas booster is a conventional device. A conventional gas compressor can be used to achieve 100 bar or more as required, but specialized hydrogen compressors would be needed that have high costs and power consumption. As the system is modular and transportable, achieving 100 bar is sufficient to reach the desired production capacity. This pressure can be increased by using a higher capacity booster. The higher capacity booster would cost more but would provide a higher outlet pressure. The preheater is a conventional-type reactor where the reactant gases are input and the temperature is raised to achieve the required output temperature. The gas booster is a mechanical device and is connected to the preheater via high-pressure fittings. The preheater is heated using coil heaters.

The reactant mixture enters the gas booster at nearly 4-30 bar and is boosted to a higher pressure of approximately 80-280 bar, preferably 145 bar plus or minus 10 bar, before being sent to the preheater or the first reactor. However, the pressure is not particularly limited and may be any suitable pressure based on the type of other components chosen in the system. Higher reactant pressures favor higher conversion rates during ammonia synthesis and are thus desirable in the process. This pressure increase is achieved in conventional plants by a hydrogen compressor or nitrogen compressor. Hence, as the system of the present invention is using a gas booster, this temperature escalation technique eliminates the use of these compressors.

The method of producing the hydrogen and similarly the method of producing nitrogen and the corresponding equipment selected result in different output pressures and temperatures for the respective devices. Thus, the process of mixing the gases and then boosting the mixture to an operating pressure can be determined by standard engineering design criteria and economics, which might not require a booster compressor.

Through the system developed in the present invention, the usage of additional compressors are avoided for recycling during ammonia synthesis. The new recycling process recycles the unreacted gases using an air-cooled condenser. The process also results in the reduced power consumption of the overall system and also cuts down the cost of a hydrogen compressor. As the unreacted gas mixture is at a higher pressure than approximately 90-155 bar, 145 bar plus or minus 10 bar, it enters the preheater reactor without the requirement of a compressor or booster. However, the pressure is not particularly limited and may be any suitable pressure based on the type of other components chosen in the system. Once the required temperature is achieved, the reactant mixture is allowed to enter the ammonia synthesis reactor, and this process is repeated in every run.

Another embodiment of the present invention is directed to a new ammonia separation system where two or more as may be required in larger systems parallel separation vessels collect liquid ammonia and allow effective unreacted gas recycling. The new recycling process recycles the unreacted gases using two parallel separation vessels and replaces a refrigeration system that is employed in conventional ammonia synthesis plants to condense ammonia and recycle the unreacted gases.

The unreacted hydrogen and nitrogen gas as well as the liquefied ammonia enter the subsystem. Two ammonia collection vessels connected in parallel at the bottom allow the liquid ammonia to settle down in both vessels with appropriate pressure balance maintenance. That is, the two parallel separation vessels separate the ammonia from the unreacted gases on the basis of pressure difference, and the liquid settles down while the unreacted gases are separated from the top. The connection of both vessels at their bottom ensures that no over-pressurization of the vessels occurs. Specifically, the two parallel separation vessels separate the ammonia from the unreacted gases on the basis of pressure difference. As the gases pass through the first pressure and gas continues to come in, the additional gas moves to the second vessel following the equilibrium, and unreacted gases are recycled once ammonia is separated. Also, in this way, the high pressure unreacted gaseous mixture passes through the recycling loop without affecting the downward setting of ammonia.

In one embodiment, the new ammonia separation system employing one or more parallel separation vessels that are used to separate the ammonia from the unreacted gases and condenser can be replaced with an absorption cooling system-based refrigeration unit. The refrigeration unit can operate via available waste heat in the system and can liquefy the synthesized ammonia from the synthesis gas stream separating the unreacted hydrogen and nitrogen and can be designed depending on the system capacities. In this way, the ammonia can be separated from the unreacted gases using the refrigeration unit instead of integrating the two parallel vessels that allow the liquid ammonia from the condenser to settle down at the bottom of the vessels with appropriate pressure balance maintenance. The waste heat to operate the refrigeration system can be obtained from the exothermic ammonia synthesis reaction as well as the compressor operation.

A multi-bed catalyst can be employed in the ammonia synthesis reactor. The catalyst may be different noble catalysts such as non-conventional ruthenium-based and wustite catalysts and traditional iron oxide catalysts or other catalysts as may be determined by the volume requirement of the system or catalyst costs and performance. This multi-bed catalyst configuration can result in the improved ammonia conversion ratios and system efficiencies. The multi-bed catalyst configuration can increase ammonia production as compared with a single conventional iron oxide-based catalyst reactor.

A further embodiment is that, again depending on the desired output, a heat exchanger can be used to partially cool the exit gases from the reactor for the purpose of reheating the recycled gases either before or after they are mixed with incoming new gases. This process serves two purposes: the first being to fully or partially recover all the reaction heat generated in the reactor and secondly to substantially reduce or eliminate the necessity to cool the reactor exit gases in a separate system.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. In the interest of fully enabling persons ordinarily skilled in the art to make and use the claimed invention, the applicant has provided information as to both advantages and disadvantages of various detailed embodiments. Persons of ordinary skill will understand that, in some applications, the disadvantages of a specific embodiment as detailed above may be avoided altogether or outweighed by the overall advantages provided by the invention as claimed. Accordingly, departures may be made from detailed teachings above without departing from the spirit or scope of applicant's general inventive concept.

1. A containerized system for producing anhydrous ammonia from air, water, and a power source capable of following up with electrical load variations, comprising:
a containerized hydrogen production unit that produces hydrogen gas from a water source;
a containerized nitrogen production unit that extracts nitrogen gas from an air source;
a containerized ammonia production unit that synthesizes ammonia from an upstream, nitrogen and hydrogen gas source.

2. The system of claim 1, wherein said containerized hydrogen production unit comprises a low temperature electrolyser, high temperature electrolyser, battolyser or by other such methods of producing hydrogen from a liquid/vapor medium where the produced hydrogen has a minimum purity of 99.995%.

3. The system of claim 2, wherein said low temperature electrolyser further comprises a proton exchange membrane (PEM) electrolyser, anion exchange membrane (AEM) electrolyser, or alkaline electrolyser.

4. The system of claim 2, wherein said high temperature electrolyser further comprises a solid oxide electrolyser.

5. The system of claim 2, wherein said other such methods of producing hydrogen from a liquid/vapor medium further comprises photoelectrochemical water splitting, CuCl, or MgCl₂ thermochemical hydrogen production process.

6. The system of claim 1, wherein said containerized hydrogen production unit comprises a water treatment and storage unit, wherein the water comprises at least one of water, brine, sea water, salty water, or waste water.

7. The system of claim 6, wherein said water treatment and storage may include a reverse osmosis process, brine purification, or a wastewater treatment process.

8. The system of claim 1, wherein said containerized hydrogen production unit comprises a hydrogen gas boosting system and buffer cylinders for hydrogen gas storage.

9. The system of claim 8, wherein said buffer cylinders for hydrogen gas storage further comprise an accumulator and bladder hydraulic system.

10. The system of claim 9, wherein said buffer cylinders for hydrogen gas storage contain phosphorus pentoxide to further dry the hydrogen gas.

11. The system of claim 1, wherein said power source comprises a power generation and storage unit to provide power to any system components that require electricity.

12. The system of claim 11, wherein said power generation and storage unit further comprises an inverter and a battery integrated system to provide electricity when power is interrupted.

13. The system of claim 11, wherein said source of power comprises renewable energy resources of at least one of wind, solar, tidal, geothermal, and hydropower connected to the grid.

14. The system of claim 1, wherein said containerized nitrogen production unit comprises an onboard air compression and storage unit that produces and stores pressurized air, a pressure swing adsorption process or other methods that use regenerative molecule that does not need any maintenance, which intakes compressed air and produces nitrogen gas through a series of adsorption and desorption processes, or other such methods of producing nitrogen from air where the produced nitrogen has a minimum purity of 99.995%.

15. The system of claim 1, wherein said containerized nitrogen production unit comprises a nitrogen gas boosting system and buffer cylinders for nitrogen gas storage.

16. The system of claim 15, wherein said buffer cylinders for nitrogen gas storage further comprise an accumulator and bladder hydraulic system.

17. The system of claim 15, wherein said buffer cylinders for hydrogen gas storage contain molecular sieve to further dry the nitrogen gas.

18. The system of claim 1, wherein said containerized ammonia production unit comprises a mixed gas boosting system that increases the pressure of a mixture of the hydrogen gas and the nitrogen gas using pressurized air.

19. The system of claim 18, wherein said containerized ammonia production unit comprises a multi-reactor assembly joint in series or in parallel suitable to control the production and maximize the yield of ammonia.

20. The system of claim 19, wherein said multi-reactor assembly further comprises two reactors wherein a first reactor preheats the mixture of the hydrogen and nitrogen gases from the mixed gas boosting system and a second reactor is loaded with a catalyst for catalyzing the preheated mixture of the hydrogen and nitrogen gases to form ammonia; and a recycle loop that separates the ammonia from unreacted gases.

21. The system of claim 20, wherein said multi-reactor assembly comprises a set number of small reactors where the production rate of ammonia is largely dependent on the number of reactors assembled together.

22. The containerized system according to claim 1, further comprising:
a loop where heat rejected by an air compressor from the air compression and storage unit is used to warm the purified water source entering the hydrogen production unit;
a first line that allows water heated by the air compressor to exit the air compressor and enter the hydrogen production unit to convert the heated water into hydrogen gas; and
a second line that allows unreacted water and oxygen to exit the hydrogen production unit and return to the loop.

23. The system according to claim 1, wherein the first reactor increases the pressure of the mixture of the hydrogen and nitrogen gases.

24. The system according to claim 1 wherein exit gases from the second reactor first pass through a heat exchanger that delivers excess heat to an input line for the first reactor while simultaneously cooling the exit gases to promote condensation of the ammonia.

25. The system according to claim 1, wherein any excess heat in exit gases from the reactor assembly is used to heat water entering the hydrogen production unit to reduce the energy required for hydrolysis.

26. The system according to claim 1, wherein the recycle loop comprises:
an air-cooled or water-cooled condenser that condenses ammonia gas into liquid ammonia.

27. The system according to claim 1, further comprising:
a compressed air storage tank that stores the pressurized air from the air compression and storage unit.

28. The system according to claim 6, wherein the recycle loop further comprises:
one or more ammonia collection vessels connected in parallel at a bottom of the collection vessels to allow the liquid ammonia to settle in both collection vessels and to keep the pressure in the collection vessels at equilibrium.

29. The system according to claim 1, wherein an exit of the mixed gas boosting system is connected to the first reactor where the mixture of the hydrogen and nitrogen gases are preheated and produce ammonia; and
wherein an exit of the first reactor is connected to the second reactor where further conversion of the mixture of the hydrogen and nitrogen gases to ammonia occurs.

30. The system according to claim 18, wherein an exit of the mixed gas boosting system is connected to both the first reactor and the second reactor.

31. The system according to claim 20, wherein the recycle loop comprises:
an absorption cooling system-based refrigeration unit that operates via waste heat in the system and liquefies ammonia gas; and
a third line that allows the unreacted gases to return to the gas booster or the first reactor.

32. The system according to claim 20, wherein the catalyst in the reactor assembly is a multi-bed catalyst.

33. A process for producing ammonia from air and water, comprising:
producing hydrogen gas from water with a proton exchange membrane electrolyser;
extracting nitrogen gas from air with a pressure swing adsorption air separation unit;
producing pressurized air with an air compressor;
increasing the pressure of a mixture of the hydrogen gas and the nitrogen gas using the pressurized air with a gas booster;
preheating the mixture of the hydrogen and nitrogen gases from the gas booster in a first reactor;
catalyzing the preheated mixture of the hydrogen and nitrogen gases to form ammonia in a second reactor loaded with a catalyst; and
separating the ammonia from unreacted gases in a recycle loop.

34. The process according to claim 33, further comprising:
pumping water in a water reservoir through the air compressor for cooling with a submersible pump;
allowing the water heated by the air compressor to exit the air compressor and enter the proton exchange membrane electrolyser to convert the heated water into hydrogen gas; and
allowing unreacted water and oxygen to exit the proton exchange membrane electrolyser and return to the water reservoir.

35. The process according to claim 33, wherein the preheating step further comprises increasing the pressure of the mixture of the hydrogen and nitrogen gases.

36. The process according to claim 33, wherein the separating step comprises:
condensing ammonia gas into liquid ammonia in an air-cooled condenser; and
allowing the unreacted gases to return to the gas booster or the first reactor.

37. The process according to claim 33, further comprising:
storing the pressurized air from the air compressor in a compressed air storage tank.

38. The process according to claim 36, wherein the separating step further comprises:
allowing the liquid ammonia to settle at a bottom of one or more ammonia collection vessels connected in parallel wherein the pressure in the collection vessels is kept at equilibrium.

39. The process according to claim 33, wherein an exit of the gas booster is connected to the first reactor where the mixture of the hydrogen and nitrogen gases are preheated and produce ammonia; and
wherein an exit of the first reactor is connected to the second reactor where further conversion of the mixture of the hydrogen and nitrogen gases to ammonia occurs.

40. The process according to claim 33, wherein an exit of the gas booster is connected to both the first reactor and the second reactor.

41. The process according to claim 33, wherein the separating step comprises:
liquefying ammonia gas with an absorption cooling system-based refrigeration unit that operates via waste heat in the system; and
allowing the unreacted gases to return to the gas booster or the first reactor.

42. The process according to claim 33, wherein the catalyst in the second reactor is a multi-bed catalyst comprising multiple beds of catalyst including both iron-based and ruthenium-based catalysts.

43. The system of claim 33, comprising a single containerized system or multiple containerized subsystems forming the transportable hydrogen and ammonia system.

44. The system of claim 43, wherein said containerized system comprises shipping containers that can be of different standard sizes and classification.

45. The system of claim 1, wherein said containerized hydrogen production unit comprises a low temperature electrolyser with intermittent hydrogen storage.

46. The system of claim 45, wherein said intermittent storage can be adapted in accordance to power availability

47. The system of claim 1, wherein said containerized ammonia production unit comprises a set of reactors that can respond to variation.

48. The system of claim 47, wherein said reactor further comprises a radial flow reactor.
